(19) United States
(12) Patent Application Publication
(10) Pub. No.: US 2026/0298716 A1
(43) Pub. Date: Oct. 1, 2026

(54) SYSTEMS AND METHODS FOR POSITIONING SENSORS IN BIOPHARMACEUTICAL STORAGE CONTAINERS

(71) Applicant: Sartorius Stedim North America Inc., Bohemia, NY (US)

(72) Inventors: Xi Chen, Levittown, NY (US); Matvey Sirotkin, Stony Brook, NY (US); Hasibullah Amani, Smithtown, NY (US); Michael Fiola, Massapequa Park, NY (US); Timothy Cardace, Bellmore, NY (US); Amy Grumet-Avallone, Smithtown, NY (US); Joseph Deacutis, Coram, NY (US); Aleksandr Shamin, Hewlett, NY (US); Stephen Honore, Uniondale, NY (US)

(73) Assignee: Sartorius Stedim North America Inc., Bohemia, NY (US)

(21) Appl. No.: 19/575,022

(22) Filed: Mar. 23, 2026

Related U.S. Application Data
(60) Provisional application No. 63/779,580, filed on Mar. 28, 2025.

(51) Int. Cl. G01J 5/02; G01J 5/04

(52) U.S. Cl. CPC G01J 5/0205; G01J 5/047

(57) ABSTRACT

A positioning system includes a base, a first holder, and a second holder. The first holder is secured to the base and defines a first receptacle and a first holder axis that extends through the first receptacle orthogonal to the base. The first holder is configured to receive a first beam generator that emits a first light beam through the base coaxial with the first holder axis. The second holder is secured to the base and defines a second receptacle and a second holder axis that extends through the second receptacle askew to the first holder axis such that the first holder axis and the second holder axis intersect at a predetermined distance from a side of the base. The second holder is configured to receive a second beam generator that emits a second light beam through the base coaxial with the second holder axis.

### CROSS-REFERENCE TO RELATED APPLICATIONS

This application claims priority to, and the benefit of, U.S. Provisional Patent Application Ser. No. 63/779,580, filed Mar. 28, 2025. The entire contents of the above applications is hereby incorporated by reference.

### BACKGROUND

### 1. Technical Field

The present disclosure relates to systems for positioning sensors and, more specifically, devices and systems for positioning thermal sensors within biopharmaceutical storage containers.

### 2. Discussion of Related Art

Development of biopharmaceutical compositions includes developing protocols for evaluating the effects of freezing, thawing, heating, cooling, storing, or transferring biopharmaceutical compositions. The biopharmaceutical compositions may be monoclonal antibodies (mAbs), therapeutic proteins, vaccines, lipid nanoparticles, viruses, virus banks, exosomes, cell banks, and cell therapy products. The methods and protocols for freezing, thawing, heating, cooling, storing, or transferring of biopharmaceutical compositions may affect the formulation and/or the stability of the biopharmaceutical compositions. To generate protocols, samples of biopharmaceutical compositions must be evaluated through freezing, thawing, heating, cooling, storage, and transfer processes to analyze the effect of the processes on the biopharmaceutical compositions and the stability thereof. Positioning thermal sensors to monitor the protocols under development can be key to optimizing the protocols. Specifically, accurate and repeatable positioning of the thermal sensors may improve protocol development during freezing and other processes. Often, one critical parameter to developing a protocol is the temperature at the last point to freeze, e.g., the center of a container, of the biopharmaceutical composition during freezing processes. As such, there is a need to improve the accuracy and repeatability of positioning of thermal sensors within containers for biopharmaceutical compositions.

### SUMMARY

This disclosure relates generally to systems for positioning thermal sensors within biopharmaceutical storage containers. Specifically, the thermal sensors may be positioned within the container using a positioning system and fixed to the container using a bracket or support assembly.

In an aspect of the present disclosure, a positioning system includes a base, a first holder, and a second holder. The base has a first side and a second side opposite the first side. The first holder is secured to the base. The first holder defines a first receptacle and a first holder axis that extends through the first receptacle orthogonal to the first side of the base. The first holder is configured to receive a first beam generator that emits a first light beam through the base coaxial with the first holder axis. The second holder is secured to the base. The second holder defines a second receptacle and a second holder axis that extends through the second receptacle askew to the first holder axis such that the first holder axis and the second holder axis intersect at a predetermined distance from the second side of the base. The second holder is configured to receive a second beam generator that emits a second light beam through the base coaxial with the second holder axis. The second holder axis is spaced apart from the first holder axis at the first side of the base.

In aspects, the second holder axis is angled with respect to the first holder axis in a range of 20 degrees to 80 degrees. The first holder axis and the second holder axis may be spaced apart a distance in a range of 5 mm to 55 mm at the first side of the base.

In some aspects, the second holder is configured to slide in a first direction to increase the predetermined distance from the second side of the base that the first holder axis and the second holder axis intersect and slide in a second direction to decrease the predetermined distance from the second side of the base that the first holder axis and the second holder axis intersect. The first holder may include a first projection extending into the first receptacle. The first projection may be configured to selectively switch the first beam generator between an on-state in which the first beam generator produces the first light beam and an off-state when the first beam generator is received in the first receptacle. The second holder may include a second projection extending into the second receptacle. The second projection may be configured to selectively switch the second beam generator between an on-state in which the second beam generator produces the second light beam and off-state when the second beam generator is received in the second receptacle.

In another aspect of the present disclosure, a system includes a storage container and a positioning system. The storage container has a first side and a second side opposite the first side. The positioning system is mounted to the first side of the storage container. The positioning system includes a base, a first holder, a first beam generator, a second holder, and a second beam generator. The first holder is secured to the base. The first beam generator is disposed within the first holder. The first beam generator is configured to emit a first light beam that extends orthogonal to the base and that passes through the storage container. The second holder is secured to the base. The second beam generator is disposed within the second holder. The second beam generator is configured to emit a second light beam that extends askew to the first light beam and that passes through the storage container. The first light beam and the second light beam intersect at a desired point within the storage container.

In aspects, the system includes a first sensor configured to detect the first light beam and a second sensor configured to detect the second light beam. The first sensor and the second sensor may be photoresistors. The first sensor and the second sensor and the second sensor may be positioned adjacent to and spaced apart from the bottom side of the storage container. The second light beam may be askew from the first light beam at an angle in a range of 20 degrees to 80 degrees. The first light beam and the second light beam may be spaced apart a distance in the range of 5 mm to 55 mm at the first side of the base.

In some aspects, the second holder may be configured to slide in a first direction to adjust the intersection of the first light beam and the second light beam away from the first side of the storage container and slide in a second direction to adjust the intersection of the first light beam and the second light beam toward the first side of the storage container. The storage container may include a bladder. The bladder may allow for transmission of light therethrough and may have a volume in a range of 5 liters to 100 liters. The positioning system may be mounted to the storage container. The first beam generator and the second beam generator may be laser beam generators. The system may include a probe disposed within the storage container with a tip portion of the probe at the desired point.

In another aspect of the present disclosure, a method of positioning a probe within a storage container includes mounting a positioning system on a first side of the storage container. The positioning system includes a first beam generator configured to emit a first light beam that passes through the storage container and a second beam generator configured to emit a second light beam that passes through the storage container and intersects the first light beam at a desired point within the storage container. The method also includes position the probe within the storage container at the desired point.

In aspects, the method includes positioning a first sensor and a second sensor adjacent to and spaced apart from a second side of the storage container opposite the first side of the storage container. The first sensor may be positioned to detect the first light beam and the second sensor may be positioned to detect the second light beam. Positioning the probe may include detecting with the first sensor when the probe obstructs the first light beam and detecting with the second sensor when the probe obstructs the second light beam. The method may also include fixing the probe with respect to the storage container such that the probe remains at the desired point during a freezing process.

In another aspect of the present disclosure, a support assembly includes a bracket, a boom, and a probe mount. The bracket has a header, a pair of arms extending from the header, a first leg extending from the header, and a second leg extending from the header. The pair of arms are configured to secure the bracket to a storage container. The first leg defines a first slot and the second leg defines a second slot. The first leg and the second leg are spaced apart to define a window therebetween. The boom defines a third slot and a fourth slot. The boom is slidably coupled to the first leg and the second leg such that the boom spans the window. The boom is slidable toward or away from the header along the first slot and the second slot. The boom is slidable transverse to the first leg or the second leg along the third slot and the fourth slot. The probe mount is fixed to the boom such that sliding the boom with respect to the bracket positions the probe mount within the window. The probe mount and the boom are configured to secure a tip portion of a probe within the storage container.

In aspects, the support assembly includes a mount hook that clamps the probe mount to the boom to fix the probe mount thereto. The probe mount may include a clamping portion. The mount hook may define a cutout that receives the clamping portion therein when the mount hook clamps the probe mount to the boom. The mount hook may define a cutout that receives the clamping portion therein when the mount hook clamps the probe mount to the boom. The clamping portion of the probe mount may have a triangular cross-section and the cutout of the mount hook may have a V-shaped profile that corresponds to the clamping portion. The mount hook may define a hook slot. The mount hook may slidably attach to the boom along the hook slot such that the sliding the mount hook in a first direction moves the cutout away from the boom to release the probe mount from the boom and sliding the mount hook in a second direction opposite the first direction moves the cutout toward the boom to clamp to clamp the probe mount to the boom. The boom may include a wall separating the third slot from the fourth slot. The mount hook may be secured to the wall.

In some aspects, the probe mount defines a probe port extending therethrough. The probe mount may be configured to receive the probe through the probe port so that the probe is disposed within an interior of the storage container and the storage container is fluidly sealed.

In certain aspects, the support assembly may include a first cam lock and a second cam lock. The first cam lock may be disposed through the first slot and the third slot to secure the boom to the first leg. The second cam lock may be disposed through the second slot and the fourth slot to secure the boom to the second leg. The first cam lock and the second cam lock may have an unlocked configuration in which the boom can slide with respect to the bracket and a locked configuration in which the boom is fixed to the bracket. The first slot may be parallel to the second slot. The arms and legs may extend from the header orthogonal to each other.

In another aspect of the present disclosure, a system includes a storage container, a probe, and a support. The storage container defines an opening in fluid communication with an interior of the storage container. The probe is disposed within the interior of the storage container through the opening. The support is secured to the storage container. The support includes a bracket, a boom, and a probe mount. The bracket has a header, a pair of arms extending from the header, a first leg extending from the header, and a second leg extending from the header. The pair of arms are configured to secure the bracket to the storage container. The first leg defines a first slot and the second leg defines a second slot. The first leg and the second leg are spaced apart to define a window therebetween. The boom defines a third slot and fourth slot. The boom is slidably coupled to the first leg and the second leg such that the boom spans the window. The boom is slidable toward or away from the header along the first slot and the second slot. The boom is slidable transverse to the first leg and the second leg along the third slot and the fourth slot. The probe mount is fixed to the boom such that sliding the boom with respect to the bracket positions the probe mount within the window. The probe mount and the boom securing a tip portion of the probe within the storage container.

In aspects, the system includes a mount hook that clamps the probe mount to the boom to secure the probe mount thereto. The boom may include a wall separating the third slot and the fourth slot. The mount hook may be secured to the wall. The storage container may include a frame. The pair of arms may secure the bracket to the frame such that the opening of the storage container is located between the first leg and the second leg.

In another aspect of the present disclosure, a method of positioning a probe within a storage containers includes securing a bracket to the storage container, attaching the probe to a boom of a bracket, positioning the probe at a desired point within the storage container, and fixing the boom with respect to the bracket such that the probe remains at the desired during a freezing process.

In aspects, positioning the probe includes using a positioning system to locate the desired point. Positioning the probe may include concurrently obstructing a first light beam and a second light beam with the probe. Positioning the probe may include concurrently obstructing a first light beam and a second light beam with the probe. Positioning the probe may include detecting the first light beam with a first sensor and detecting the second light mean a second sensor. Positioning the probe may include sliding the boom along a first slot and a second slot defined by the bracket to position the probe at a first vertical position within the storage container sliding the boom align a third slot and a fourth slot defined by the boom to position the probe at a first horizontal position within the storage container, and determining if the probe obstructs the first light beam and the second light beam. Positioning the probe may include sliding the boom along the first slot and the second slot to position the probe at a second vertical position within the storage container, sliding the probe at a second vertical position within the storage container, sliding the boom along the third slot and the fourth slot to position the probe at a second vertical horizontal position within the storage container, and determining if the probe obstructs the first light beam and the second light beam.

In another aspect of the present disclosure, a support assembly includes a bracket, a clamp, and a probe. The bracket has a first side and a second side opposite the first side. The bracket includes a pair of arms extending from the first side and a track extending from the second side. The pair of arms are configured to secure the bracket to a storage container. The track defines a slot extending therethrough. The clamp is slidably attached to the track along the slot. The clamp is pivotable about a clamp axis thereof. The probe mount is received by the clamp. The probe mount and the clamp are configured to secure a tip portion of a probe within the storage container.

In aspects, the clamp includes a pair of clamp fingers. The pair of clamp fingers may define a holder sized and dimensioned to receive the probe mount between the pair of clamp fingers. Each clamp finger may include an end portion. The end portions may be spaced apart a distance that is in a range of 3 percent to 8 percent smaller than a diameter of the holder.

In some aspects, the probe mount defines a probe port extending therethrough. The probe mount may be configured to receive the probe mount through the probe port so that the probe is disposed within the interior of the storage container and the storage container is fluidly sealed. Each leg may terminate in a foot that is angled in the range of 89 degrees to 70 degrees with respect to the respective leg.

In certain aspects, the support assembly includes a cam lock having an unlocked configuration in which the clamp can slide within the track and rotate about the clamp axis and a locked configuration in which the clamp is fixed with respect to the bracket. The clamp axis may be orthogonal to the bottom side of the bracket.

In another aspect of the present disclosure, a system includes a storage container, a probe, and a support assembly. The storage container defining an opening in fluid communication with an interior of the storage container. The probe is disposed within the interior of the storage container. The support assembly is secured to the storage container. The support assembly includes a bracket having a first side and second side opposite the first side. The bracket includes a pair of legs extending from the side and a track extending from the second side. The pair of legs are configured to secure the bracket to the storage container. The track defines a slot extending therethrough. The clamp is slidably attached to the track along the slot. The clamp is pivotable about a clamp axis thereof. The probe mount is received by the clamp. The probe mount and the clamp secure a tip portion of the probe within the storage container.

In aspects, the clamp includes a pair of clamp fingers. The pair of clamp fingers may receive the probe mount therebetween. Each leg may terminate in a foot that is angled in the range of 89 degrees to 70 degrees with respect to the respective leg.

In some aspects, the system includes a two-part fastener includes a first part and a second part. The first part of the two-part fastener may be adhered to each foot of the bracket and the second part of the two-part fastener adhered to the storage container. Engagement of the first part and second part of the two-part fastener securing the bracket to the storage container. The system may include a cam lock having an unlocked configuration in which the clamp can slide within the track and rotate about the clamp axis and a locked configuration in which the clamp is fixed with respect to the bracket. The storage container may be a bladder having a volume in the range in the range of 1 liter to 15 liters. The bladder may allow transmission of light therethrough. The clamp axis may be orthogonal to the second side of the bracket.

In another aspect of the present disclosure, a method of positioning a probe within a storage container includes securing a bracket to the storage, attaching the probe to clamp of the bracket, positioning the probe at a desired point within an interior of the storage container, and fixing the clamp with respect to the bracket such that the probe remains at the desired point during a freezing process or thawing process.

In aspects, positioning the probe includes using a positioning system to locate the desired point. Positioning the probe may include concurrently obstructing a first light beam and a second light beam with probe. Positioning the probe may include concurrently obstructing a first light beam and a second light beam with the probe. Positioning the probe may include detecting the first light beam with a first sensor and a second light beam with a second sensor. Positioning the probe may include sliding the clamp within a track of the bracket and rotating the clamp about a clamp axis to position a tip portion of the probe at a first position and determining if the tip portion obstructs the first light beam and the second light beam. Positioning the probe may include sliding the clamp within the track of the bracket and rotating the clamp about the clamp axis to position the tip portion of the probe at a second position and determining if the tip portion obstructs the first light beam and the second light beam.

In another aspects of the present disclosure, a positioning system includes a base, a first holder, and a second holder. The base has a first side and second side opposite the first side. The first holder is secured to the base. The first holder defines a first receptacle and a first holder axis that extends through the first receptacle orthogonal to the first side of the base. The first holder is configured to receive a first beam generator that emits a first light beam through the base coaxial with the first holder axis. The second holder is secured to the base. The second holder defines a second receptacle and a second holder axis that extends through the second receptacle askew to the first holder axis such that the first holder axis and the second holder axis intersect at a predetermined distance from the second side of the base. The second holder is configured to receive a second beam generator that emits a second light beam through the base coaxial with the second holder axis. The second holder axis spaced apart from the first holder axis at the first side of the base.

In aspects, the second holder is configured to slide in a first direction to increase the predetermined distance from the second side of the base that the first holder axis and the second holder axis intersect and slide in a second direction to decrease the predetermined distance from the second side of the base that the first holder axis and the second holder axis intersect. The first holder may include a first projection extending into the first receptacle. The first projection may be configured to selectively switch the first beam generator between an on-state in which the first beam generator produces the first the first light beam and an off-state when the first beam generator is in the first receptacle. The second holder axis may be angled with respect to the first holder axis in a range of 20 degrees to 80 degrees. The first holder axis and the second holder axis may be spaced apart a distance in a range of 5 mm to 55 mm at the first side of the base.

In another aspect of the present disclosure, an apparatus includes a storage container, a first beam generator, a second beam generator, and a positioning system. The storage container has a first side and a second side opposite the first side. The storage container defines an interior of the storage container between the first side and the second side. The first beam generator has an on-state in which a first light beam is emitted. The second beam generator has an on-state in which a second light beam is emitted. The positioning system is mounted to the first side of the storage container. The positioning system includes a base, a first holder, and a second holder. The base has a first side and second side opposite the first side. The first holder is secured to the base. The first holder defines a first receptacle and a first holder axis that extends through the first receptacle orthogonal to the first side of the base. The first holder is configured to receive a first beam generator that emits a first light beam through the base coaxial with the first holder axis. The second holder is secured to the base. The second holder defines a second receptacle and a second holder axis that extends through the second receptacle askew to the first holder axis such that the first holder axis and the second holder axis intersect at a predetermined distance from the second side of the base. The second holder is configured to receive a second beam generator that emits a second light beam through the base coaxial with the second holder axis. The second holder axis spaced apart from the first holder axis at the first side of the base. The first beam generator is disposed within the first holder of the positioning system and the second beam generator is disposed within the second holder of the positioning system. The first light beam and the second light beam intersect at a desired point within the interior of the storage container.

In aspects, the apparatus includes a probe disposed within the interior of the storage container with a tip portion of the probe at the desired point. The apparatus may include a support assembly secured to the storage container. The support assembly may include a bracket, a boom, and a probe mount. The bracket may be configured to secure to the storage container. The boom may be slidably coupled to the bracket. The boom may be slidable to the bracket in two degrees of freedom. The probe mount may secure the probe to the boom such that sliding the boom with respect to the bracket positions the tip portion of the probe within the storage container at the desired point.

In some aspects, the apparatus includes a support assembly secured to the storage container. The support assembly may include a bracket, a clamp, and a probe mount. The bracket may be configured to be secured to the storage container. The clamp may be slidably attached to the bracket. The clamp may be slidable relative to the bracket in one degree of freedom. The clamp may be pivotable about a clamp axis thereof. The probe mount may be received by the clamp. The probe mount may be received by the clamp. The probe mount may secure the probe to the clamp such that sliding or pivoting the clamp positions the tip portion of the probe within the storage container at the desired point.

In another aspect of the present discloser, an apparatus includes a storage container, a positioning system, and a probe. The storage container has a first side and a second side opposite the first side. The positioning system is mounted to the first side of the storage container. The positioning system includes a base, a first holder secured to the base, first beam generator, a second holder secured to the base, and a second beam generator. The first beam generator is disposed within the first holder. The first beam generator is configured to emit a first light beam that extends orthogonal to the base and the passes through the storage container. The second beam generator is disposed within the second holder. The second beam generator is configured to emit a second light beam that extends askew to the first light beam and that passes through the storage container. The first light beam and the second light beam intersect at a desired point within the storage container. The probe is disposed within the storage container with a tip portion of the probe at the desired point.

In aspects, the apparatus includes a first sensor configured to detect the first light beam and a second sensor configured to detect the second light beam. The first sensor and the second sensor may be photoresistors. The first sensor and the second sensor may be positioned adjacent to and spaced apart from second side of the storage container.

In some aspects, the storage container includes a bladder. The bladder may allow transmission of light therethrough and have a volume in a range of 5 liters to 100 liters. The positioning system may be mounted to the storage container.

In certain aspects, the apparatus includes a support secured to the storage container. The support includes a bracket, a boom, and a probe mount. The bracket may include a header, a pair of arms extending from the header, a first leg extending from the header, and a second leg extending from the header. The pair of arms may secure the bracket to the storage container. The first leg and the second leg may be spaced apart to define a window therebetween. The boom may be slidably coupled to the first leg and the second leg such that the boom spans the window. The probe mount may secure the probe to the boom such that sliding the boom with respect to the bracket positions the probe within the storage container at the desired point. The first leg may define a first slot and the second leg may define a second slot. The boom may define a third slot and fourth slot. The boom may be slidable toward or away from header along the first slot and the second slot. The boom may be slidable transvers to the first leg and the second leg along the third slot and the fourth slot. The storage container may include a frame. The pair of arms may secure the bracket to the frame such that an opening of the storage container is located between the first leg and the second leg. The probe may be disposed within the storage container through the opening.

In some aspects, the apparatus includes a support assembly secured to the storage container. The storage container may include a bracket, a clamp, and a probe mount. The bracket may have a first side and a second side opposite the first side. The bracket may include a pair of legs extending from the first side and a track extending from the second side. The pair of the legs may secure the bracket to the storage container. The track may define a slot extending therethrough. The clamp may be slidably attached to the track and slidable along the slot. The clamp may be pivotable about a clamp axis thereof. The probe mount may secure the probe to the clamp such that sliding or pivoting the clamp positions the tip portion of the probe within the storage container at the desired point. The apparatus may include a two-part fastener including a first part and a second part. The first part of the two-part fastener may be adhered to each foot of the bracket and the second part of the two-part fastener may be adhered to the storage container. Engagement of the first part and the second part of the two-part fastener may secure the bracket to the storage container.

In another aspect of the preset disclosure, a method of positioning a probe within a storage container includes mounting a positioning system on a first side of the storage containers. The positioning system includes a first beam generator configured to emit a first light beam that passes through the storage container and a second beam generator configured to emit a second light beam that passes through the storage container and intersects the first light beam at a desired point within the storage container. The method also include positioning the probe within the storage container at the desired point.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are not necessarily drawn to scale, which are incorporated in and constitute a part of this specification, wherein:

FIG. 1 is a perspective view of a storage container including thermal sensor systems provided in accordance with embodiments of the present disclosure;

FIG. 2 is a schematic view of a bladder of the storage container of FIG. 1;

FIG. 3 is a perspective view of a probe support assembly of the storage container of FIG. 1;

FIG. 4 is a perspective view of a positioning system in accordance with embodiments of the present disclosure;

FIG. 5 is a top view of the positioning system of FIG. 4;

FIG. 6 is a right-side view of the positioning system of FIG. 4;

FIG. 7 is a section view of the positioning system of FIG. 4 taken along section line A-A of FIG. 6;

FIG. 8 is a perspective view of another positioning system in accordance with embodiments of the present disclosure;

FIG. 9 is a schematic view of a system for positioning a probe within a storage container including the positioning system of FIG. 4 in accordance with embodiments of the present disclosure;

FIG. 10 is a perspective view of a top side of the system of FIG. 9;

FIG. 11 is a perspective view of a bottom side of the system of FIG. 9;

FIG. 12 is a flowchart of a method of positioning a probe within a storage container with a positioning system in accordance with embodiments of the present disclosure;

FIG. 13 is a perspective view of another support assembly in accordance with embodiments of the present disclosure mounted to the container of FIG. 1;

FIG. 14 is another perspective view of the support assembly of FIG. 13;

FIG. 15 is an exploded view of the support assembly of FIG. 14;

FIG. 16 is a front view of the support assembly of FIG. 14;

FIG. 17 is a perspective view of a probe mount of the support assembly of FIG. 13;

FIG. 18 is a top view of the probe mount of FIG. 17;

FIG. 19 is a section view of the probe mount of FIG. 17 taken along section line B-B of FIG. 18;

FIG. 20 is a perspective view of a mount hook of the support assembly of FIG. 13;

FIG. 21 is a front view of the mount hook of FIG. 20;

FIG. 22 is a flowchart of a method of positioning a probe within a storage container with a support assembly in accordance with embodiments of the present disclosure;

FIG. 23 is a perspective view of another support assembly in accordance with embodiments of the present disclosure mounted to a storage container in accordance with embodiments of the present disclosure;

FIG. 24 is an enlarged perspective view of the support assembly mounted to the storage container of FIG. 23;

FIG. 25 is a perspective view of the support assembly of FIG. 23;

FIG. 26 is a left side view of the support assembly of FIG. 25;

FIG. 27 is a perspective view of a clamp of the support assembly of FIG. 25;

FIG. 28 is a top view of the clamp of FIG. 25;

FIG. 29 is a perspective view of a probe mount of the support assembly of FIG. 23; and

FIG. 30 is a flowchart of a method of positioning a probe within a storage container with a support assembly in accordance with embodiments of the present disclosure.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

As used herein, the phrase “configured to” describes a related element that must be made, suited by nature, character, or designed for a particular use, purpose, or situation. In contrast, the phrase “capable of” describes a related element that only needs to be suitable for a particular use, purpose, or situation.

As used herein, the term “biopharmaceutical compositions” refers to a product coming from biotechnology, culture environments, cell cultures, buffer solutions, artificial nutrition liquids, blood products and derivatives of blood products, a pharmaceutical product, or more generally a product intended to be used in the medical field including, without any limitation, monoclonal antibodies (mAbs), therapeutic proteins, viruses, lipid nanoparticles, vaccines, virus banks, exosomes, cell banks, and cell therapy products. As used herein, the term “cryogenic” refers to temperatures in a range of −20° Celsius to −196° Celsius unless otherwise specified.

Referring now to FIG. 1, a storage container 100 provided in accordance with the present disclosure. The storage container 100 is designed to receive a fluid, e.g., a biopharmaceutical composition, and hold the fluid through freezing, storage, shipping, thawing, and distribution. The storage container 100 may be aseptic or sterile depending on the fluid being stored therein. The storage container 100 may include a frame 110 and a bladder 120. The frame 110 may be formed of a rigid material to contain and protect the bladder 120. The frame 110 may form a rectangular enclosure to hold the bladder 120 therein.

The frame 110 may include side rails 112 and corner elements 114 that join the side rails 112 together. The corner elements 114 may be of a material configured to absorb force without deforming. For example, the corner elements 114 may be formed of a plastic, e.g., a thermoset or a thermoplastic, which can impact another storage container 100 or structure without being damaged or breaking. The corner elements 114 may be configured to function at cryogenic temperatures. In some embodiments, the corner elements 114 may be formed of a metal such as aluminum or stainless steel. The side rails 112 may be formed of a metal such as aluminum or stainless steel. In some embodiments, the side rails 112 may be formed of a plastic material. The frame 110 is stackable with other frames 110 such that multiple storage containers 100 may be stacked on top of one another.

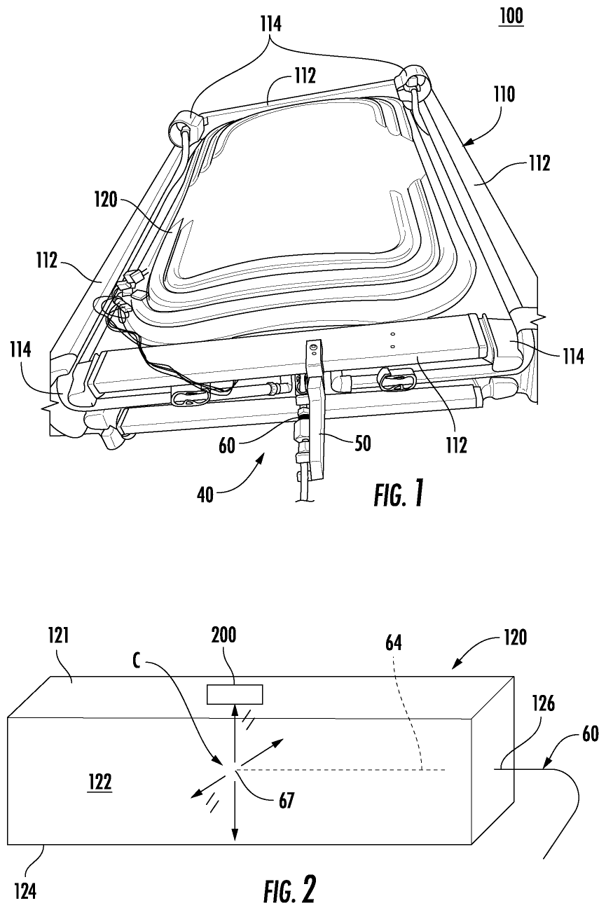

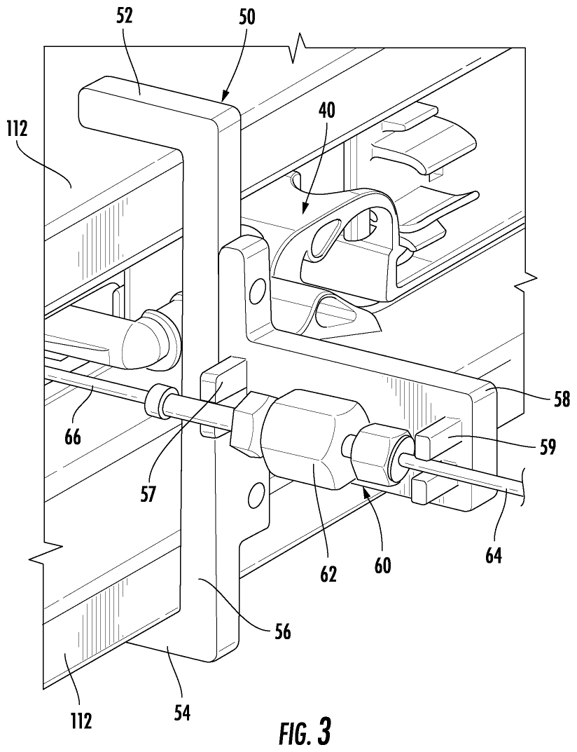

With additional reference to FIG. 2, the bladder 120 is disposed within the frame 110. The frame 110 supporting the bladder 120 within the frame 110 and protecting the bladder 120. The bladder 120 is formed of a flexible material that expands and collapses in response to being filled and drained, respectively. For example, when the bladder 120 is empty, the bladder 120 may be collapsed with a minimal amount of air or gas in an interior 122 of the bladder 120. As the storage container 100 and thus, the bladder 120, is filled with a fluid, the bladder 120 expands. When the bladder 120 is filled, the frame 110 maintains the bladder 120 in a substantially rectangular prismatic shape. The bladder 120 is transparent or translucent such that the bladder 120 allows the transmission of light therethrough. While filled with a fluid, the bladder 120 may continue to allow transmission of light therethrough.

During freezing, storage, and thawing of a fluid within the storage container 100, it may be advantageous to know the temperature of the fluid within the bladder 120 of the storage container 100. Specifically, as a fluid is frozen or thawed, the fluid may freeze or thaw at different rates depending on where in the bladder 120 the temperature is being measured. For example, portions of a fluid adjacent the extremities or outside edges of the bladder 120 may change temperature more quickly than portions of the fluid at or adjacent the center “C” of the bladder 120. The different rates may be based on conduction and/or convection within the interior 122 of the bladder 120 and may affect the rate at which the fluid changes temperature. In embodiments, properties of the fluid itself may affect the rate at which the fluid changes temperature. Monitoring the temperature of the fluid at the last point to freeze of the storage container 100 may be advantageous to the developing protocols for production and manufacture of fluids. The last point to freeze is the point within the interior 122 of the bladder 120 where a fluid is last to freeze during a freezing process. In some embodiments, the center C may be the last point to freeze of the bladder 120. Controlling the last point to freeze may be an important parameter to control in the manufacture of some biopharmaceutical compositions, e.g., where cryo-concentration processes are utilized. Additionally or alternatively, controlling the last point to freeze may improve the repeatability, quality control, and scaling of freezing processes. During protocol development, a temperature sensor may be positioned at a desired point P within the storage container 100 to measure the temperature of a fluid during a freezing process. In embodiments, a plurality of temperature sensors may be positioned at several respective desired points P. The desired point P may be the last point to freeze.

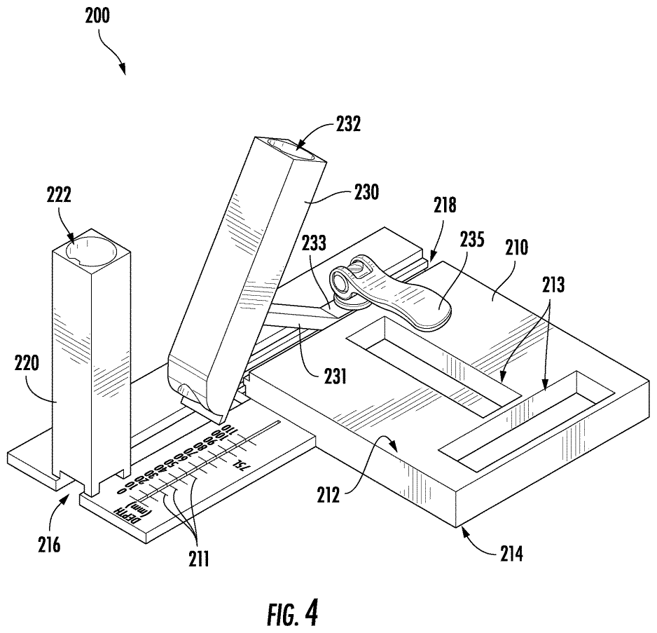

With reference to FIG. 3, an internal thermal probe system is described in accordance with the present disclosure and is referred to generally as probe system 40. The probe system 40 is attachable to the storage container 100 and directly measures the temperature of contents of the storage container 100. The probe system 40 includes a support assembly 50 and a probe assembly 60. The support assembly 50 mounts to a side rail 112 of the storage container 100 to position and secure the probe assembly 60 relative to the storage container 100.

The probe assembly 60 includes a probe 66, e.g., a temperature probe such as a thermocouple or a thermistor, having a tip or tip portion 67. The tip portion 67 of the probe 66 may be positioned at or adjacent the center C of the bladder 120 when secured by the support assembly 50. The probe 66 is a sensor capable of directly measuring a temperature of the contents of the bladder 120 at the tip portion 67.

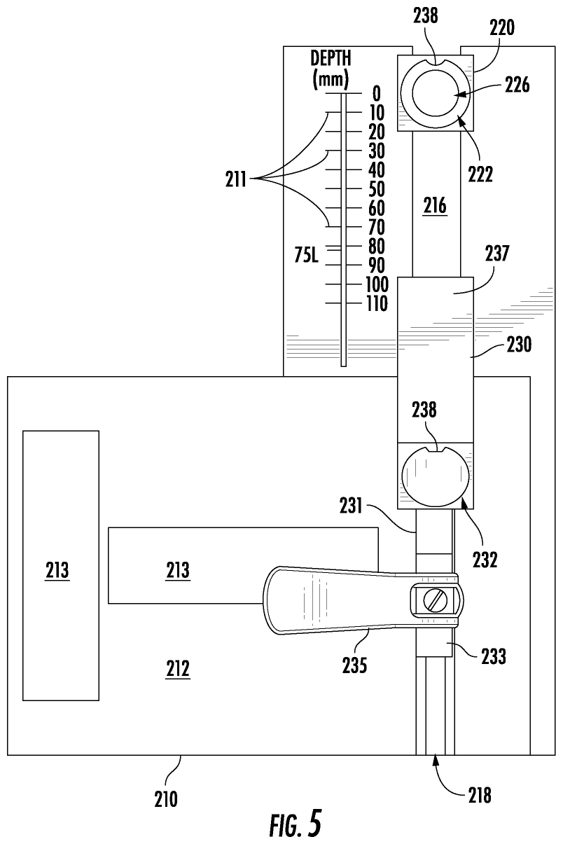

Referring now to FIGS. 4-7, a positioning system 200 in accordance with embodiments of the present disclosure is shown. The positioning system 200 is configured to position the tip portion 67 of the probe 66 within the bladder 120. The positioning system 200 is attached to the storage container 100 such that beams of light pass through the bladder 120 to aid in the positioning of the tip portion 67. The positioning system 200 may be used to position the tip portion 67 at a desired point P, e.g., the center C of the bladder 120, within the interior 122 of the bladder 120. As described in greater detail below, when the tip portion 67 concurrently disrupts both the beams of light within the bladder 120, the tip portion 67 is positioned at the desired point P.

The positioning system 200 includes a base 210, a first holder 220, and a second holder 230. The base 210 has a first or top side 212 and a second or bottom side 214. The base 210 may define cavities 213 in the top side 212 that may receive a level, e.g., a bubble level. The cavities 213 may be oriented perpendicularly to each other such that positioning system 200 may be leveled with respect to the storage container 100. Leveling the positioning system 200 allows for accurate and repeatable positioning of the tip portion 67 within the bladder 120. Leveling the positioning system 200 when mounted to the storage container 100 may ensure that one of the light beams 223 (FIG. 9) pass through the bladder 120 orthogonally to a first or top side 121 and a second or bottom side 124 of the bladder 120.

The first holder 220 extends orthogonally from the top side 212 and the second holder 230 extends from the top side 212 askew from the top side 212. The first holder 220 and the second holder 230 may be secured to the top side 212 of the base 210. In embodiments, the first holder 220 and the second holder 230 may be monolithically formed with the base 210. More specifically, the first holder 220 defines a first holder axis C₁-C₁ and the second holder 230 defines a second holder axis C₂-C₂. The second holder 230 extends from top side 212 with the second holder axis C₂-C₂ angled with respect to the first holder axis C₁-C₁ at an angle γ in the range of 1 degree to 80 degrees, e.g., 5, 10, 20, 30, 45, 60, or 75 degrees. The base 210 defines an opening(s) 216 aligned with the first holder 220 and the second holder 230 such that the first holder axis C₁-C₁ and the second holder axis C₂-C₂ pass through a respective opening 216 and intersect at a point P spaced apart from the bottom side 214 of the base 210.

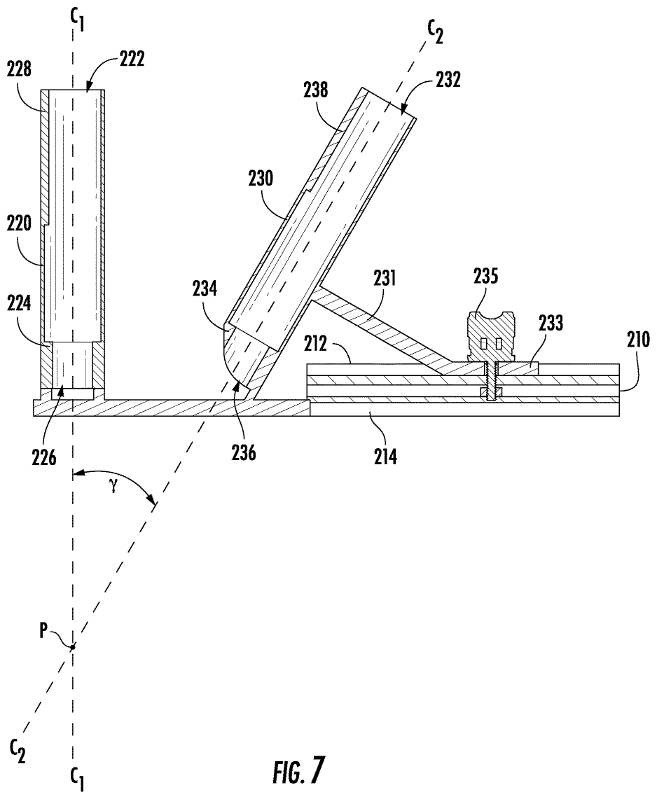

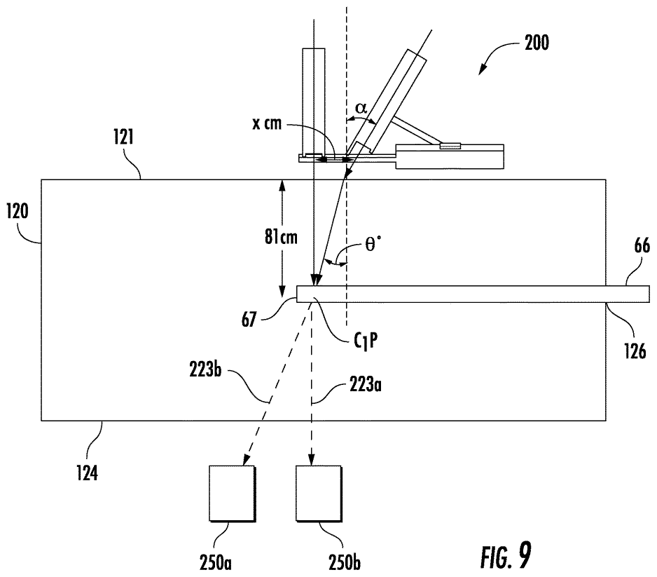

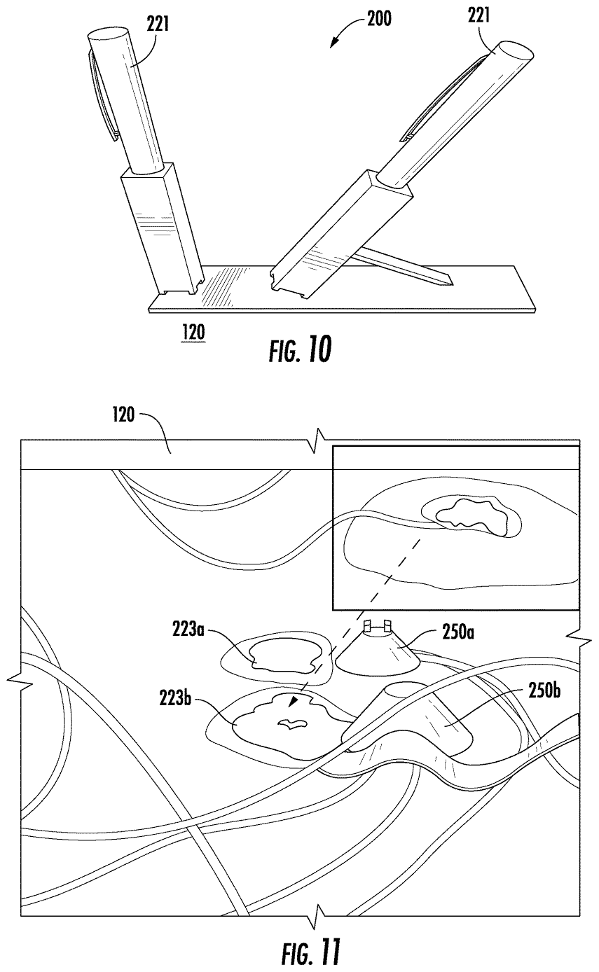

With particular reference to FIG. 7, the first holder 220 defines a first receptacle 222 and the second holder 230 defines a second receptacle 232. The receptacles 222, 232 each receive a beam generator 221 (FIG. 10), e.g., a light beam generator, a laser pointer, or laser generator. The beam generators 221 may have an on-state, in which the beam generators 221 each emit a light beam 223 (FIG. 9), and an off-state, in which the beam generators 221 do not emit a light beam 223. The first holder 220 includes a first shelf 224 and the second holder 230 includes a second shelf 234 extending into the receptacles 222, 232. The first shelf 224 defines a first aperture 226 and the second shelf 234 defines a second aperture 236. The light beam 223 passes through the respective aperture 226, 236 when in the on-state. The apertures 226, 236 may be coaxially aligned with the receptacles 222, 232. The receptacles 222, 232 and the apertures 226, 236 may be coaxially aligned with the first holder axis C₁-C₁ and the second holder axis C₂-C₂, respectively. The shelves 224, 234 may engage the beam generators 221 to align the beam generators 221 within the apertures 226, 236. For example, the shelves 224, 234 may center the beam generators 221 within the receptacles 222, 232 and/or the apertures 226, 236 so that the light beams 223 are co-linear with the first holder axis C₁-C₁ and the second holder axis C₂-C₂. In such an embodiment, the engagement between the shelves 224, 234 and the beam generators 221 may be self-centering within the respective receptacle 222, 232. The shelves 224, 234 may define the apertures 226, 236 to have a tapered, e.g., funneled, profile that centers the beam generators 221 within the apertures 226, 236. Additionally or alternatively, the beam generators 221 may have a conical profile at or near the end of the beam generators 221 that emits the light beam 223 that engages the shelves 224, 234 to center the beam generators 221 within the apertures 226, 236. As such, when the beam generators 221 are received within the receptacles 222, 232 and are in the on-state the light beams 223 pass through the apertures 226, 236 and the base 210 colinearly with the first holder axis C₁-C₁ and the second holder axis C₂-C₂ and intersect at the point P.

The holders 220, 230 may each include a projection 228, 238, respectively, extending into the respective receptacle 222, 232. The projections 228, 238 may switch the beam generators 221 between the on-state and the off-state. For example, the beam generators 221 may be switched between the on-state and the off-state by rotating the beam generators 221 within the receptacles 222, 232. Rotating the beam generators 221 within the receptacles 222, 232 may engage a button of the beam generators 221 with the projections 228, 238 to selectively switch the beam generators 221 between the on-state and the off-state.

In embodiments, the bottom side 214 of the base 210 of the positioning system 200 may be configured to secure the positioning system 200 to the storage container 100. In embodiments, the positioning system 200 may secure to a side rail 112 or a corner element 114. In some embodiments, positioning system 200 may be secured to the bladder 120. For example, the bottom side 214 of the base 210 may have an adhesive to secure the positioning system 200. The adhesive may be a removable or re-stickable adhesive to temporarily secure the positioning system 200 to the storage container 100. In some embodiments, the bottom side 214 of the base 210 includes an anti-slip material that frictionally engages the storage container 100 to maintain the location of the positioning system 200. For example, the bottom side 214 may have a rubberized material, e.g., a silicone rubber, which grips the material of the storage container 100 to resist movement of the positioning system 200 relative to the center C of the bladder 120.

In embodiments, the second holder 230 is adjustable. For example, the second holder 230 may slide or translate with respect to the first holder 220. Translating the second holder 230 increases or decreases the distance between the first holder 220 and the second holder 230. More particularly, translating the second holder 230 increases or decreases the distance between the first holder axis C₁-C₁ and the second holder axis C₂-C₂ and, thus, adjusts the position of the point P with respect to the bottom side 214 of the base 210. For example, translating the second holder 230 towards the first holder 220 may adjust the point P to be closer to the bottom side 214 and translating the second holder 230 away from the first holder 220 may adjust the point P to be further from the bottom side 214. The second holder 230 may be translated to space the first holder axis C₁-C₁ and the second holder axis C₂-C₂ apart a distance in the range of 5 mm to 55 mm at the top side 212 of the base 210. The base 210 may include a plurality of depth marks 211 to indicate the distance the point P is spaced from the bottom side 214 of the base 210. In such an embodiment, the second holder 230 may have an aiming edge 237 that aligns with one of the depth marks 211 to indicate the distance the point P is spaced from the bottom side 214 of the base 210.

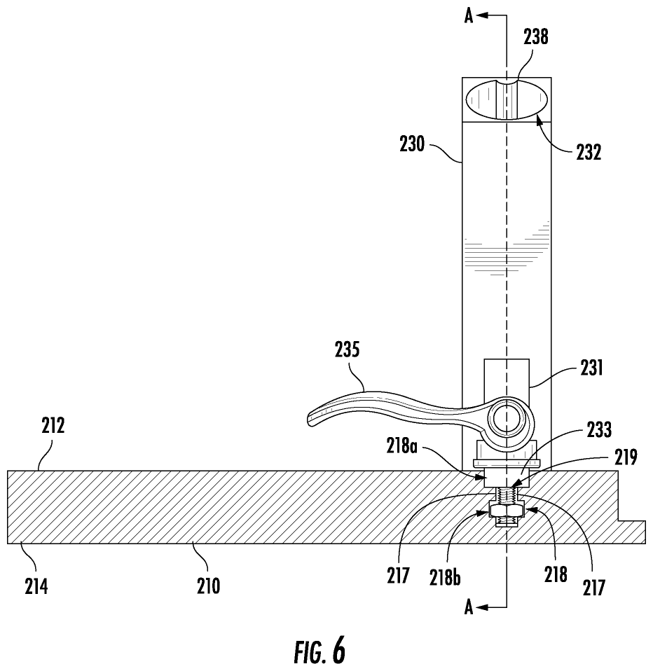

Referring to FIG. 6, the base 210 may define a track 218 to guide the second holder 230 as the second holder 230 translates. Specifically, the track 218 includes eaves 217 extending into the track 218 to split the track 218 into an upper track 218a and a lower track 218b. The upper track 218a and the lower track 218b are connected by a gate 219 defined between the ends of the eaves 217. The second holder 230 may include a brace 231 that has a guide portion 233 received within the track 218. As the second holder 230 translates the guide portion 233 slides along the track 218. A lock 235 may secure the second holder 230 to the base 210 and fix the position of the second holder 230 with respect to the first holder 220. For example, as shown in FIGS. 4-7, the lock 235 may be a cam clamp. In such an embodiment, the cam clamp may have a locked configuration in which the second holder 230, and more specifically the guide portion 233, freely slides along the track 218 and a locked configuration in which the second holder 230 is secured at a fixed position. Specifically, the lock 235 may clamp the caves 217 and the guide portion 233 together to fix the second holder 230 relative to the base 210 and the first holder 220.

In some embodiments, the angle γ between the first holder axis C₁-C₁ and the second holder axis C₂-C₂ is adjustable. The angle γ may be adjusted to be at any angle in the range of 1 degree to 80 degrees, e.g., 15, 30, 45, 60, or 75 degrees. In such an embodiment, the second holder 230 may be hinged to the base 210 to swing to a desired angle γ. In certain embodiments, the second holder 230 is replaceable to adjust the angle γ. Specifically, the positioning system 200 may be a kit including a plurality of second holders 230 that are configured to attach to the base 210 with a different angle γ.

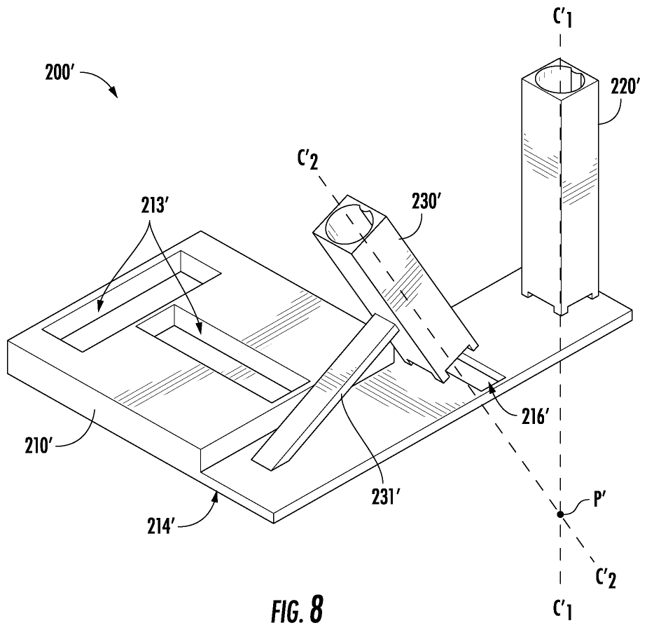

Referring now to FIG. 8, another positioning device is disclosed in accordance with embodiments of the present disclosure and is referred to generally as positioning system 200′. The positioning system 200′ is similar to the positioning system 200 of FIGS. 4-7 with like elements represented with similar labels including a prime notation. For reasons of brevity, only the differences between the positioning system 200 and the positioning system 200′ will be detailed herein. In embodiments where the second holder 230′ is fixed, the second holder 230′ may include a brace 231′ without a guide portion 233. The second holder 230′ is spaced apart from the first holder 220′ at a fixed distance in the range of 5 mm to 55 mm. As such, the point P′ may be spaced from the bottom side 214′ of the positioning system 200′ a fixed distance.

With reference to FIGS. 9-11, the positioning system 200 may be mounted to the storage container 100 to aid in positioning the probe 66 within the storage container 100. In embodiments, the positioning system 200 maybe mounted to the top side 121 of the bladder 120. When the beam generators 221 are in the on-state, the light beams 223 emitted from the beam generators 221 pass through the storage container 100. The light beams 223 intersect at the point P, which is a desired point within the storage container 100, e.g., the interior 122 of the bladder 120, for positioning the tip portion 67 of the probe 66. In embodiments, the point P and the center C may be coincident. The light beams 223 may pass through the storage container 100 and exit a side of storage container 100 opposite the side the light beam entered, e.g., through the bottom side 124 of the bladder 120. When the probe 66 is positioned at the point P, the probe 66 obstructs each of the light beams 223. The probe 66 being at the point P may be visually indicated or sensed by a sensor 250. To visually indicate that the probe 66 is at the point P the light beams 223 may be completely or partially obstructed on the exit side of the storage container 100. For example, the light beams 223 may be completely or partially obstructed on the bottom side 124 of the bladder 120 or on a worksurface, e.g., a table, that the storage container 100 sits. For example, the probe 66 may cast a shadow as a result of intersecting the light beams 223 on the worksurface.

With particular reference to FIG. 11, sensors 250 may be positioned on or adjacent to the storage container 100 to detect the presence or intensity of the light of the light beams 223. In some embodiments, the sensors 250 are adhered to the storage container 100. More specifically, the sensors 250 may be adhered to the bladder 120. In certain embodiments, the sensors 250 are positioned adjacent to and space apart from the storage container 100, e.g., on a worksurface that the storage container 100 sits. The sensors 250 may be photoresistors. In such embodiments, when the probe 66 does not obstruct the light beams 223 the sensors 250 may detect light from the light beams 223. The sensors 250 may be electrically coupled to an indicator (not shown) that indicates the presence or absence of light from the light beams 223. For example, the indicator may illuminate a lightbulb, e.g., an LED, for visual indica, may make an audible noise as an indica, or both to indicate when the light from light beams 223 are detected, or not detected, by the sensors 250.

In some embodiments, the indicator may be a multimeter and that measures an electrical resistance through the sensors 250. When the probe 66 obstructs the light beams 223 the resistance reading on the multimeter(s) may increase or decrease to indicate that the probe 66 is in the path of the light beam 223. When the probe 66 is in the path of both light beams 223, the tip portion 67 is at the point P. More particularly, when the probe 66 obstructs the light beam 223a, emitted from the beam generator 221 within the first holder 220, the sensor 250a detects the presence of the probe 66 and returns a corresponding reading on the respective multimeter and when the probe 66 obstructs the beam 223b, emitted from the beam generator 221 within the second holder 230, the sensor 250b detects the presence of the probe 66 and returns a corresponding reading on the respective multimeter. When both sensors 250a, 250b detect the probe 66, then the tip portion 67 of the probe 66 is at the point P.

When the light beams 223 enter or exit the storage container 100, the light beams 223 may refract. Refraction of the light beams 223 may shift the point P. More particularly, a light beam 223a emitted from the beam generator 221 in the first holder 220 may not be refracted as a result of entering the storage container 100 orthogonally to the surface and a second light beam 223b emitted from beam generator 221 in the second holder 230 may be refracted as a result of entering the storage container 100 at an angle away from orthogonal. The light beams 223a, 223b refract according to Snell's law:

$$\frac{Sin α}{Sin θ} = \frac{{η}_{1}}{{η}_{air}}$$

Where α (alpha) is the angle of incident of the light beams 223a, 223b, e.g., the angle γ between the first holder axis C₁-C₁ and the second holder axis C₂-C₂, θ (theta) is the angle of refraction of the light beams 223a, 223b, η₁ (eta one) is the refractive index of the fluid within the storage container 100, e.g., when the fluid is water, η₁=1.33, and ηₐᵢᵣ (eta air) is the refractive index of air, e.g., ηₐᵢᵣ=1. Refraction may cause the second light beam 223b to intersect the light beam 223a at a point closer or further from the bottom side 214 of the positioning system 200 along the first holder axis C₁-C₁, depending on the indices of refraction.

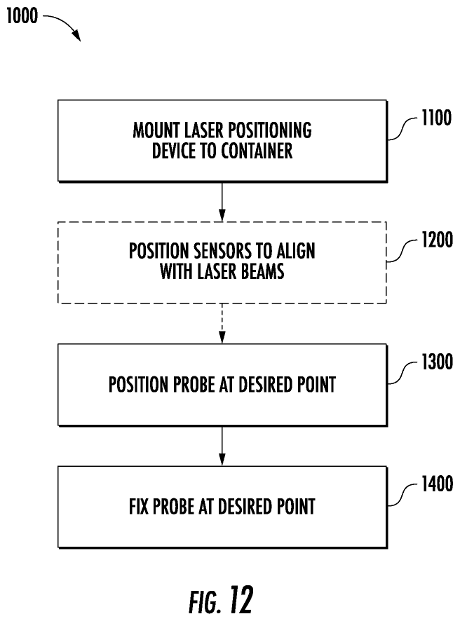

Referring to FIG. 12, a method 1000 of positioning a probe within a container in accordance with embodiments of the present disclosure is described with reference to the storage container 100 of FIGS. 1-3 and the positioning system 200 of FIGS. 4-11. The method 1000 may be used to position the tip portion 67 of the probe 66 at a desired point P within the interior 122 of the storage container 100. As such, the distance between the first holder axis C₁-C₁ and the second holder axis C₂-C₂ may be adjusted to compensate for refraction by sliding the second holder 230.

The positioning system 200 is mounted to the storage container 100 (Step 1100). The positioning system 200 may be mounted at any point on the storage container 100. For example, the positioning system 200 may be mounted at any point on the top side 121 of the bladder 120 to assist in positioning the probe 66 within the interior 122. If the probe 66 is to be positioned at the center C of bladder 120, the positioning system 200 may be positioned at the center of the top side 121. Specifically, the positioning system 200 may be positioned on the top side 121 of the bladder 120 such that the first holder axis C₁-C₁ passes through the center C of the bladder 120. In embodiments, the top side 121 of the bladder 120 includes a center mark located directly above the center C of the bladder 120 when the bladder 120 is filled. For example, the center mark may be a circle printed or embossed on the top side 121 to aid in alignment of the first receptacle 222 with the center C. Mounting the positioning system 200 may include leveling the positioning system 200 with respect to the plane containing the desired point P parallel to the surface of the storage container 100 that the positioning system 200 is mounted. For example, when the positioning system 200 is mounted on the top side 121 of the bladder 120 may be a substantially flat surface parallel to the plane containing the desired point P. In such an embodiment, the positioning system 200 may not need leveling. In some embodiments, the top side 121 of the bladder 120 may be arcuate or domed, as shown in FIG. 1, which may cause the positioning system 200 to tilt. Tilting of the positioning system 200 may direct the light beams 223 away from the desired point P within the bladder 120. As such, the positioning system 200 may need to be leveled so that the bottom side 214 is parallel with a top surface of the frame 110, e.g., a top surface of one of the side rails 112. The positioning system 200 may be leveled by shims placed under the base 210 between the top side 121 of the bladder 120 and the bottom side 214 of the base 210. In particular embodiments, the bottom side 214 of the base 210 may be contoured, e.g., concave, to conform to the top side 121 of the bladder 120 when the bladder 120 is filled. In such an embodiment, the positioning system 200 may not require leveling. In some embodiments, the base 210 may rest on the frame 110 of the storage container 100.

In some embodiments, sensors 250 may be positioned on or adjacent to the bottom side 124 of the bladder 120 to detect the light beams 223 (Step 1200). In embodiments, the sensors 250 may be adhered to the bottom side 124 of the bladder 120. In some embodiments, the sensors 250 may be positioned on a work surface adjacent to the bottom side 124 of the bladder 120. The sensors 250 detect the light from the light beams 223 passing through the bladder 120. For example, when the sensors 250 are photoresistors, the sensor 250 may detect light from the light beams 223 as increasing or decreasing resistance corresponding to the presence or intensity of light from the light beams 223. The resistance many be displayed on the multimeter coupled to the respective sensor 250. In some embodiments, a visual and/or audible indicia will sound when light is detected or when there is an absence of light.

The method 1000 includes positioning the tip portion 67 of the probe 66 at a desired point P within the bladder 120 (Step 1300). To position the tip portion 67 of the probe 66, the tip portion 67 is inserted into the bladder 120 through the opening 126 and positioned with the tip portion 67 of the probe 66 at the desired point P, e.g., the center C of the bladder 120. The probe 66 is at the point P when the light beams 223a, 223b are concurrently obstructed by the probe 66. The probe 66 may be determined to be at the point P visually by the probe 66 partially obstructing or completely obstructing the light beams 223a, 223b. For example, when the probe 66 is at the point P the light beams 223a, 223b may be partially visible on the bottom side 124 of the bladder 120 or the light beams 223a, 223b may not be visible at all. Additionally or alternatively, the probe 66 may be positioned at the point P with the aid of the sensors 250. When the sensors 250 are used, the indicator may provide a visual or audible indica that the tip portion 67 of the probe 66 is at the point P.

Inserting the probe 66 through the opening 126 may align the probe 66 with the desired point P in two directions. Specifically, the opening 126 may be aligned with the center C of the bladder 120, as shown in FIG. 2. When the probe 66 is received through the opening 126 the opening 126 may substantially align the probe 66 in the vertical direction, e.g., between the top side 121 and the bottom side 124 of bladder 120, and the transverse direction, e.g., parallel to the top side 121 and the bottom side 124. The depth of the tip portion 67 is inserted into the bladder 120 may be determined by the length of the probe 66. The probe 66 may have a predetermined length so that when the probe 66 is fully inserted into the opening 126 the tip portion 67 is at a depth within the bladder 120 to be positioned at the point P. In embodiments, the probe 66 includes a depth gauge to indicate the tip portion 67 is at the desired depth. For example, the depth gauge may be a ring or a mark along the length of the probe 66 that, when aligned with an entrance to the opening 126, indicates the tip portion 67 is at the depth to be positioned at the point P.

Briefly referring back to FIG. 9, in some embodiments, the positioning system 200 may indicate the direction to adjust the probe 66 during positioning the tip portion 67. Specifically, when the tip portion 67 obstructs only one light beam 223a, 223b, which of the light beams 223a, 223b the tip portion 67 obstructs may indicate the direction to adjust the probe 66 to position the tip portion 67 at the desired point P. Which one of the light beams 223a, 223b is obstructed by the tip portion 67 may be visually indicated or indicated by the sensors 250. The probe 66 may first be positioned horizontally within the bladder 120. When the probe 66 is fully inserted in the bladder 120 and the tip portion 67 is at the appropriate depth to be positioned at the desired point P, moving the probe 66 horizontally across the bladder 120 will cause the tip portion 67 to obstruct at least one of the light beams 223a, 223b. Once one of the light beams 223a, 223b is obstructed, the tip portion 67 may be horizontally positioned within the bladder 120. Which of the light beams 223a, 223b the tip portion 67 obstructs during horizontal positioning may indicate, e.g., visually or by sensing, the direction the probe 66 needs to move in the vertical direction, toward the top side 121 or the bottom side 124 of the bladder 120, to be positioned at the desired point P. For example, if the tip portion 67 is only obstructing the light beam 223b, then moving the probe 66 downward away from the top side 121 will move the tip portion 67 towards the desired point P. If the tip portion 67 is only obstructing the light beam 223a, then moving the tip portion 67 upward away from the bottom side 124 will move the tip portion 67 towards the desired point P.

The bladder 120 may have a flexible nature. Due to the flexible nature of the bladder 120, the location of the opening 126 on the bladder 120 and the length of the probe 66 may not fully constrain the tip portion 67 to the center C when the probe 66 is disposed within the bladder 120. Specifically, the weight of the probe 66 may cause the wall of the bladder 120 to flex or buckle depending on the fill level of the bladder 120. Flexing of the bladder 120 may cause the tip portion 67 to become displaced from the center C. The support assembly 50 may bear some or all of the weight of the probe 66 to prevent displacement of the tip portion 67 from the desired point P. In embodiments, the desired point P for placing the tip portion 67 is not coincident with the center C. The flexible nature of the bladder 120 may provide for positioning the tip portion 67 at a point other than the center C. For example, the flexibility of the bladder 120 may allow for deflecting the probe 66 to be nearer the top side 121 or the bottom side 124 of the bladder 120. Additionally or alternatively, less than the entire length of the probe 66 may be inserted into the bladder 120 to position the tip portion 67 at a point closer to the opening 126. In embodiments, a longer probe 66 may be used to position the tip portion 67 at a point farther from the opening 126.

When the tip portion 67 is positioned at the desired point P, the probe 66 is fixed to the storage container 100 (Step 1400). The probe 66 is fixed by the support assembly 50 to maintain the tip portion 67 at the point P. Specifically, the support assembly 50 is secured to the frame 110 of the storage container 100. The frame 110 and the support assembly 50 are rigid and hold the probe 66 fixed with respect to the bladder 120, e.g., at the center C of the bladder 120. The support assembly 50 may secure to one or more side rails 112 of the frame 110. Securing the support assembly 50 to the frame 110 may maintain the tip portion 67 at the desired point P during one or more processes. For example, the support assembly 50 may fix the tip portion 67 of the probe 66 at the point P throughout freezing processes, thawing processes, or transportation of the storage container 100.

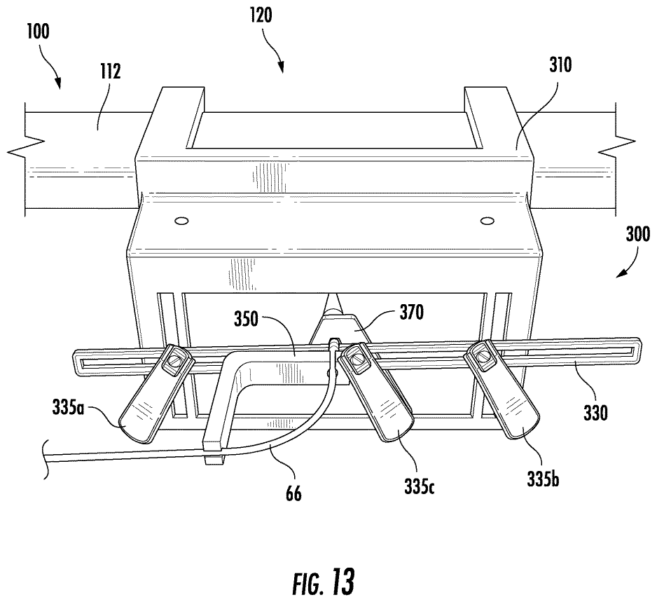

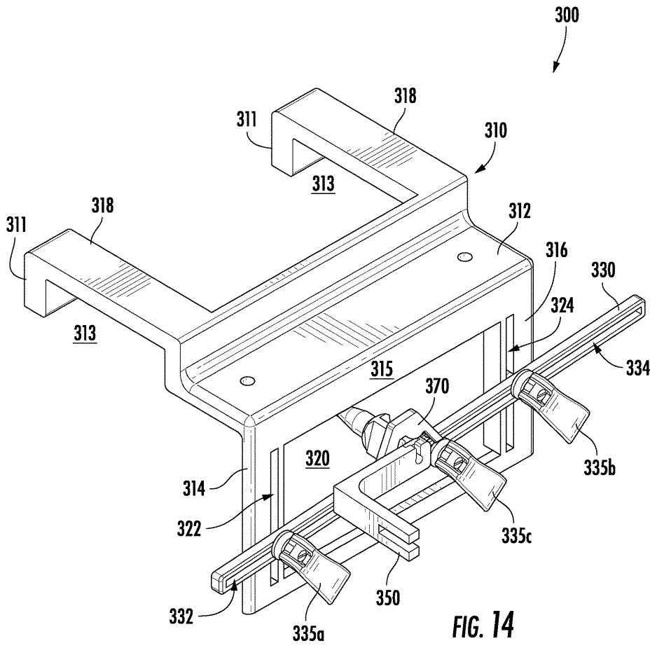

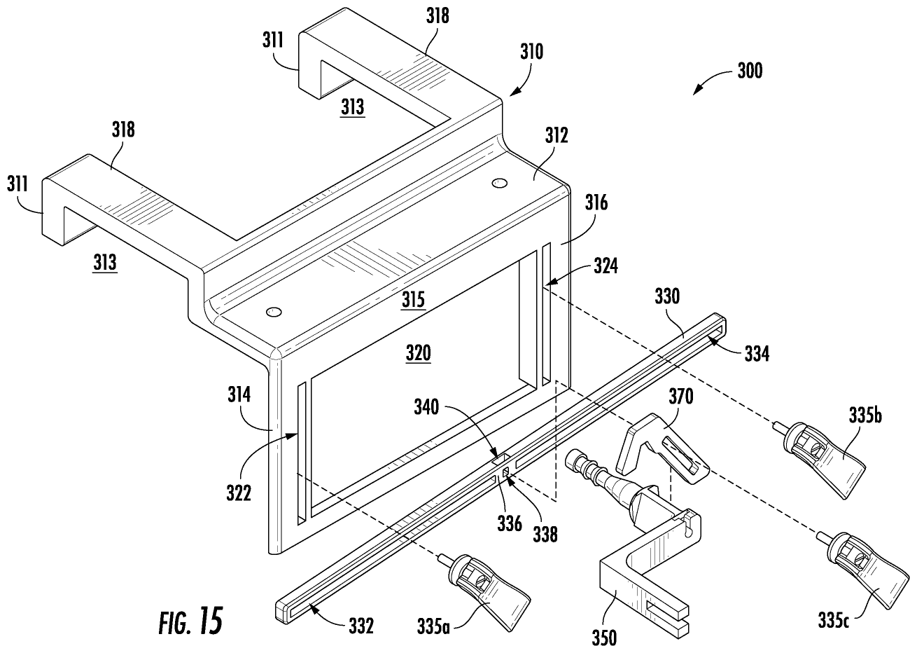

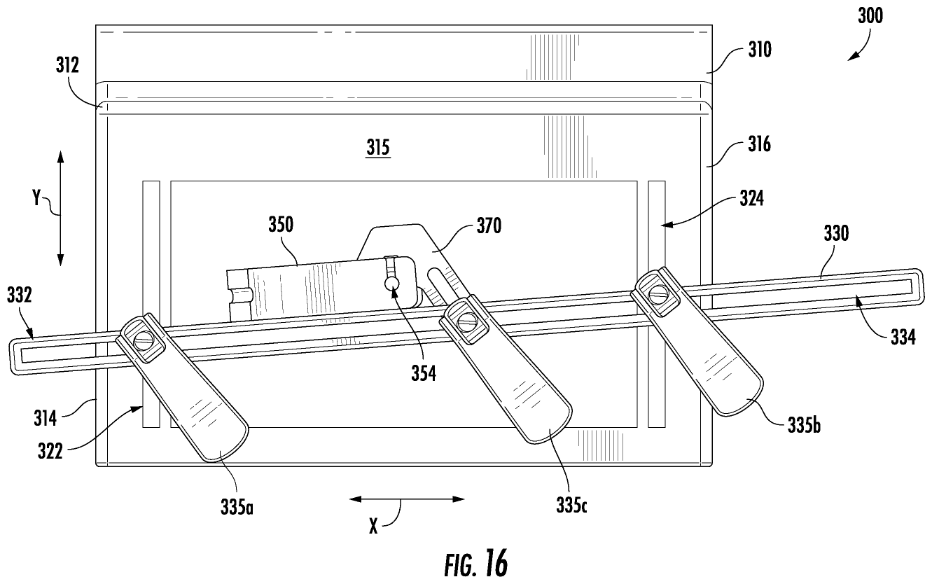

Referring to FIGS. 13-16, another support assembly 300 is provided in accordance with embodiments of the present disclosure. The support assembly 300 fixes the probe 66 to the storage container 100 to maintain the tip portion 67 at the desired point P during a freezing or thawing process. The support assembly 300 may be used to partially fix one or more degrees of freedom of the probe 66 during positioning of the tip portion 67. The support assembly 300 mounts to the frame 110 of the storage container 100 and secures the probe 66 at a desired position, e.g., the center C, within the bladder 120 of the storage container 100. The support assembly 300 provides at least two degrees of freedom to position the probe 66 within the bladder 120. Specifically, as shown in FIG. 16, the support assembly 300 allows for horizontal, e.g., X-position, and vertical, e.g., Y-position, positioning of the probe 66 within the storage container 100. The length of the probe 66 disposed within the storage container 100, dictates the depth, e.g., Z-position (into the page), the probe 66 penetrates into the bladder 120. Constraining motion of the probe 66 during positioning within the bladder 120 may ease and speed positioning of the tip portion 67 at the desired point P. For example, constraining motion of the probe 66 may be held to verify that the tip portion 67 is obstructing one or more light beams.

The support assembly 300 includes a bracket 310, a boom 330, a probe mount 350, and a mount hook 370. The bracket 310 secures the support assembly 300 to a side rail 112 of the storage container 100. The bracket 310 includes a header 312, a first leg 314, a second leg 316, and a pair of arms 318. The first leg 314, the second leg 316, and the pair of arms 318 extend from the header 312 orthogonally to each other such that the bracket 310 is generally L-shaped. The pair of arms 318 engage with the side rail 112 to secure the bracket 310 to the storage container 100. Each arm 318 of the pair of arms 318 have a hook portion 311. The pair of arms 318 may define a gap 313 with the header 312 to receive the side rail 112 and secure the bracket 310 to the frame 110. The pair of arms 318 may be sized and dimensioned such that when the side rail 112 is received in the gap 313 frictionally engages the hook portions 311 and the header 312 to secure the bracket 310 to the frame 110. In some embodiments, the arms 318 may be adjustable to allow the bracket 310 to secure to frames 110 of different sizes and dimensions. For example, the arms 318 may be extendable to increase or decrease the distance between the hook portions 311 and the header 312 and thereby adjust the gap 313. In such an embodiment, the arms 318 may clamp the bracket 310 to the side rail 112. In embodiments, the arms 318 may include grip pads, e.g., rubber pads, attached to each arm 318 within the gap 313. The grip pads may improve securement between the bracket 310 and the side rail 112. The grip pads may resist sliding along the length of the side rail 112. Additionally or alternatively, the grip pads may compress when the gap 313 receives the side rail 112 to form a snug fit between the bracket 310 and the frame 110.

The legs 314, 316 extend from the header 312, spaced apart, to define a window 320 therebetween. The window 320 may be enclosed as shown in FIG. 14. In embodiments, the window 320 is open on the side opposite the header 312 without a cross member extending between the legs 314, 316. The first leg 314 and the second leg 316 may be parallel to each other. The first leg 314 defines a first slot 322 and the second leg 316 defines a second slot 324. The first slot 322 and the second slot 324 may be defined so as to be parallel to each other. In some embodiments, the first slot 322 or the second slot 324 may be arcuate. When the bracket 310 is secured to the storage container 100 with the opening 126 of the storage container 100 is positioned in the window 320 between the legs 314, 316. The legs 314, 316 may extend from the header 312 to form a cage 315 that the boom 330 slides along, as described below. For example, the legs 314, 316 may each have a front surface that are coplanar with each other and the boom 330 slides along the front surfaces of the legs 314, 316. The legs 314, 316 may include guide features extending from each leg 314, 316. The guide features may be disposed on both sides of each slot 322, 324 and define a guide channel, e.g., a T-slot, aligned with first slot 322 and the second slot 324. The guide channel may receive a portion of a lock 335 when the support assembly 300 is assembled. The guide features may assist movement between boom 330 and the legs 314, 316. The guide features may be positioned on a rear side of the legs 314, 316, opposite the side the boom 330 slides along the legs 314, 316.

Continuing to refer to FIGS. 13-16, the boom 330 is slidably attached to the bracket 310. Specifically, the boom 330 is slidably attached to the legs 314, 316 and spans the window 320. The boom 330 may translate along the cage 315 of the bracket 310 vertically or transversely with respect to the window 320, guided by the slots 322, 324. The boom 330 may be an elongate member. The boom 330 defines a third slot 332 and a fourth slot 334. A wall 336 of the boom 330 separates the third slot 332 and the fourth slot 334. The wall 336 may be centrally located along the length of the boom 330 so that the third slot 332 and the fourth slot 334 are of equal length. In some embodiments, the wall 336 may be positioned along the length of the boom 330 off-center such that the third slot 332 or the fourth slot 334 is longer than the other of the third slot 332 or the fourth slot 334. The wall 336 may define a hole 338. The hole 338 may receive a portion of a lock 335 to secure the mount hook 370 to the boom 330. In embodiments, the wall 336 is a double wall, as shown, with a front wall and a rear wall that define a pocket 340 between the front wall and the rear wall to receive a portion of the lock 335c to fix the lock 335c to the boom 330. For example, the pocket 340 may receive a nut that secures the lock 335c to the boom 330. In some embodiments, the wall 336 is a single wall, without the pocket 340.

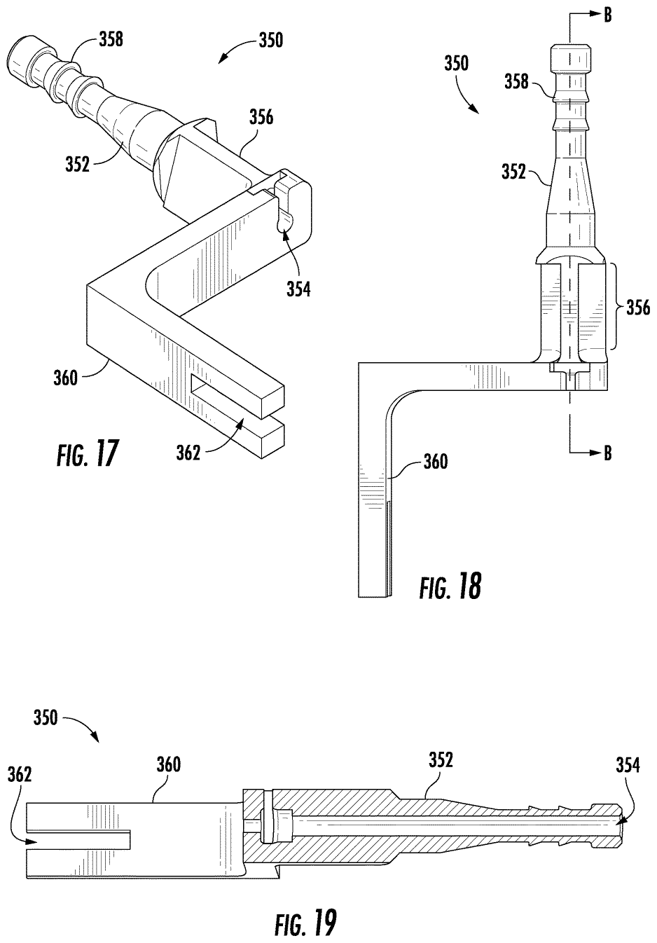

Referring to FIGS. 17-19, the probe mount 350 receives the probe 66 and is secured to the boom 330. In some embodiments, the probe mount 350 and the boom 330 may be formed as a unitary body. The probe mount 350 includes a receiver 352 and a probe rest 360. The probe mount 350 may be generally Z-shaped with the receiver 352 and the probe rest 360 extending in opposite directions from each other. The receiver 352 defines a probe port 354 to receive the probe 66. The receiver 352 receives the probe 66 such that the bladder 120 is fluidly sealed through the probe port 354. For example, the receiver 352 may include gaskets, e.g., rubber O-rings, to engage the probe 66 to seal the probe port 354. The receiver 352 may include a clamp segment 356 for clamping the probe mount 350 to the boom 330. The clamp segment 356 may have a polygonal cross-section to provide for clamping against the boom 330. For example, the clamp segment 356 may have a generally triangular cross-section as shown in FIG. 21. In some embodiments, the clamp segment 356 may have a square cross-section or hexagonal cross-section. The receiver 352 may have a fitting 358 to fluidly couple the probe mount 350 to the bladder 120. For example, as shown, the fitting 358 may be a barb fitting that is received in and fluidly seals the opening 126 of the bladder 120. The probe rest 360 may support a portion of the probe 66. For example, the probe rest 360 may resist rotation of the probe 66 within the probe port 354. In some embodiments, the probe rest 360 may provide a backstop to indicate that the probe 66 is fully disposed within the storage container 100. More particularly, the probe rest 360 may define a dock 362 to receive the portion of the probe 66. When the probe 66 is fully seated in the dock 362 the tip portion 67 of the probe 66 may be positioned at the desired depth within bladder 120, e.g., the Z-position.

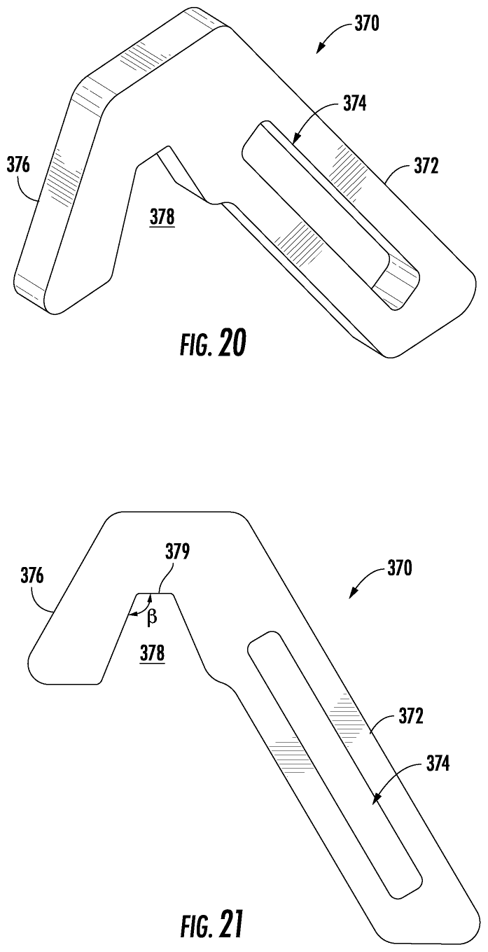

Referring to FIGS. 20 and 21, the mount hook 370 clamps the probe mount 350 to the boom 330. The mount hook 370 has a body 372 that defines a hook slot 374 and a head 376 that defines a cutout 378. The mount hook 370 slides along the hook slot 374 with respect to the boom 330 to clamp and release the probe mount 350 to the boom 330. The cutout 378 has a profile that cooperates with the clamp segment 356 of the probe mount 350. For example, the cutout 378 may have a triangular or V-shaped profile to receive the triangular cross-section of the clamp segment 356. The V-shaped cutout 378 may have a contact angle β such that the head 376 contacts the clamp segment 356 along the entire profile of the cutout 378. In embodiments, the contact angle β may be in the range of 60 degrees to 70 degrees, e.g., 67 degrees. In some embodiments, the cutout 378 may be wider than the clamp segment 356 of the probe mount 350. Specifically, the V-shaped profile of the cutout 378 may have a contact angle β such that only a contact surface 379 of the mount hook 370 contacts the clamp segment 356. For example, the contact angle β may be 2 degrees to 10 degrees, e.g., 6 degrees, greater than in an embodiment where the head 376 contacts the clamp segment 356 along the entire profile of the cutout 378. The wider cutout 378 may allow for rotation, e.g., yaw, of the probe mount 350 to assist in positioning the tip portion 67 the probe 66. The mount hook 370 may clamp the probe mount 350 to either side of the boom 330. For example, the probe mount 350 may be clamped to the top side of the boom 330, as shown, or the probe mount 350 may be clamped to the bottom side of the boom 330.

The boom 330 may be attached to the bracket 310 by a first lock 335a and a second lock 335b and the mount hook 370 may be attached to the boom 330 by a third lock 335c. The first lock 335a extends through the first slot 322 and the third slot 332 and the second lock 335b extends through the second slot 324 and the fourth slot 334 to slidably attach the boom 330 to the legs 314, 316. The third lock 335c extends through the hook slot 374 and slidably attaches the mount hook 370 to the wall 336 of the boom 330 between the third slot 332 and the fourth slot 334. The locks 335a, 335b, 335c may be cam clamps. The cam clamps may have a locked configuration in which the boom 330 freely slides along the first slot 322 and the second slot 324 and the mount hook 370 slides along the hook slot 374 and a locked configuration in which the boom 330 and the mount hook 370 are secured at fixed positions with respect to the bracket 310 and, thus, the storage container 100. In some embodiments, the locks 335 may be bolts with a wing nut.

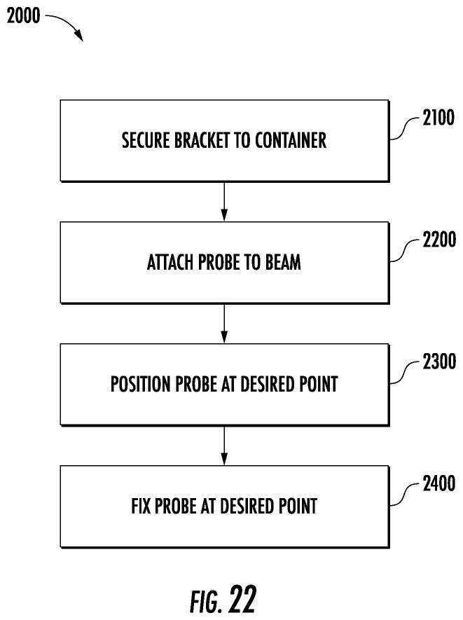

Referring to FIG. 22, a method 2000 of positioning a probe within a container in accordance with embodiments of the present disclosure is described with reference to the storage container 100 of FIGS. 1-3, the positioning system 200 of FIGS. 4-12, and the support assembly 300 of FIGS. 13-21. The method 2000 may be used to position the tip portion 67 of the probe 66 at a desired point P within the interior 122 of the storage container 100.

The bracket 310 is secured to the frame 110 of the storage container 100 (Step 2100). Specifically, the pair of arms 318 are hung on a side rail 112 with the side rail 112 received in the gap 313. In embodiments where the pair of arms 318 are adjustable, the pair of arms 318 may be adjusted so that the gap 313 is sized and dimensioned to receive the side rail 112. The bracket 310 may be secured to the frame 110 alone or with components of the support assembly 300 attached to the bracket 310. For example, the bracket 310 may be secured to the side rail 112 with the boom 330 attached to the legs 314, 316. During securement of the bracket 310 to the frame 110 the boom 330 may be fixed by the locks 335 or may be free to slide in the slots 322, 324.

The probe 66 is attached to boom 330 (Step 2200). Attaching the probe 66 to the boom 330 may include inserting the probe 66 into the probe mount 350 through the probe port 354. The probe 66 may contact gaskets within the probe mount 350 to fluidly seal the probe port 354. In embodiments, attaching the probe 66 to boom 330 may include clamping the probe mount 350 to the boom 330 with the mount hook 370. The probe mount 350 may be clamped to the boom 330 before or after inserting the probe 66 into the probe port 354. In some embodiments, attaching the probe 66 to the boom 330 includes attaching the boom 330 to the legs 314, 316 of the bracket 310. The boom 330 may be attached to the bracket 310 before or after the probe mount 350 is secured to the boom 330.

The tip portion 67 of the probe 66 is positioned at a desired point P within the storage container 100 (Step 2300). More particularly, the tip portion 67 is positioned at the desired point P within the bladder 120 to monitor the temperature, or other parameters, of the fluid contained within the bladder 120. The tip portion 67 is positioned by sliding the boom 330 with respect to the bracket 310 along the cage 315. Sliding the boom 330 along the cage 315 as guided by the slots 322, 324, 332, 334 locates the probe mount 350 within the window 320 and, thus, the tip portion 67 of the probe 66 within the interior 122 of the bladder 120. The position of the probe mount 350 within the window 320 may position the probe 66 horizontally and vertically within the bladder 120. The depth the tip portion 67 extends into the bladder 120 may be defined by the length of the probe 66.

The tip portion 67 of the probe 66 may be positioned with the aid of the positioning system 200. As described above, the positioning system 200 may intersect two light beams 223 at a point P, e.g., the desired point P for the tip portion 67 of the probe 66. When the probe 66 obstructs both the light beams 223 the probe 66 is at the desired point P. To position the tip portion 67 horizontally within the bladder 120, the boom 330 may be translated horizontally from left to right or right to left until the tip portion 67 obstructs either one of the light beams 223a, 223b. Once the horizontal position is found, the boom 330 and the probe 66 may be translated vertically either up or down within the window 320 depending on which of the light beams 223a, 223b the tip portion 67 obstructs during horizontal positioning. When the tip portion 67 obstructs only one of the light beams 223a, 223b, which of the light beams 223a, 223b the tip portion 67 obstructs may indicate the direction the boom 330 should be translated to position the tip portion 67 at the desired point P. For example, with brief reference back to FIG. 9, if the tip portion 67 is only obstructing the light beam 223b, then translating the boom 330 downward will move the tip portion 67 towards the desired point P. If the tip portion 67 is only obstructing the light beam 223a, then translating the boom 330 upward will move the tip portion 67 towards the desired point P. In embodiments, the probe 66 may be positioned before or after the bladder 120 is filled with a fluid.

The probe 66 is fixed at the desired point (Step 2400). Specifically, the boom 330 is fixed to the legs 314, 316 of the bracket 310. The boom 330 is fixed by moving the first lock 335a and the second lock 335b to the locked configuration. Moving the locks 335a, 335b to the locked configuration clamps the boom 330 to the legs 314, 316. Fixing the boom 330 to the bracket 310 resists displacement of the tip portion 67 from the desired point P during subsequent processes, e.g., freezing processes.

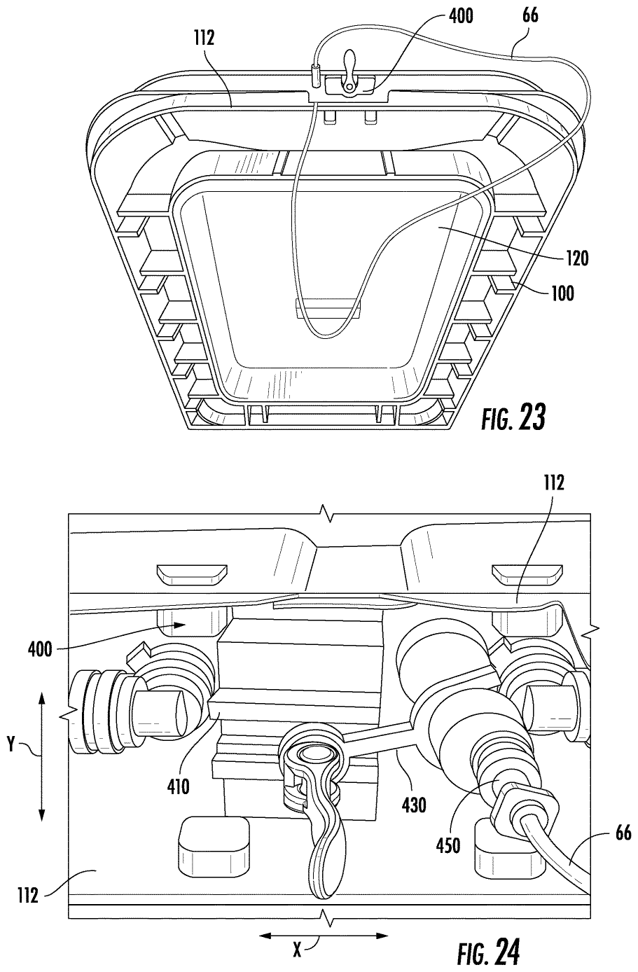

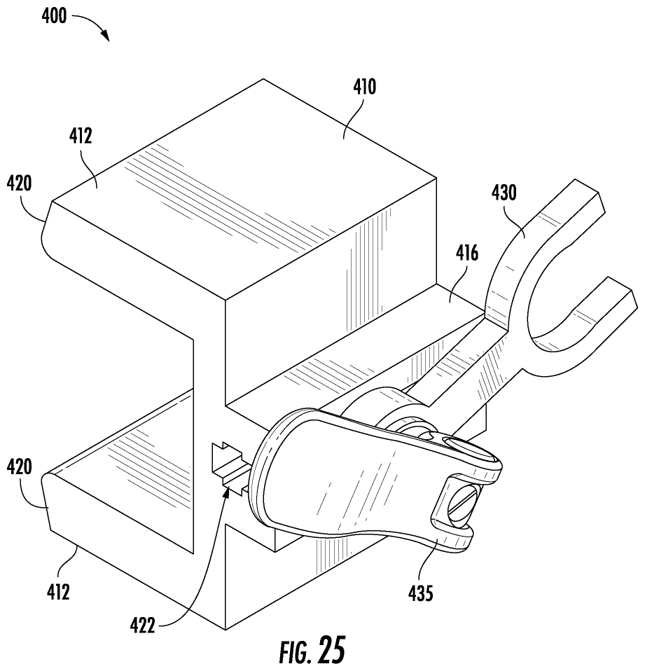

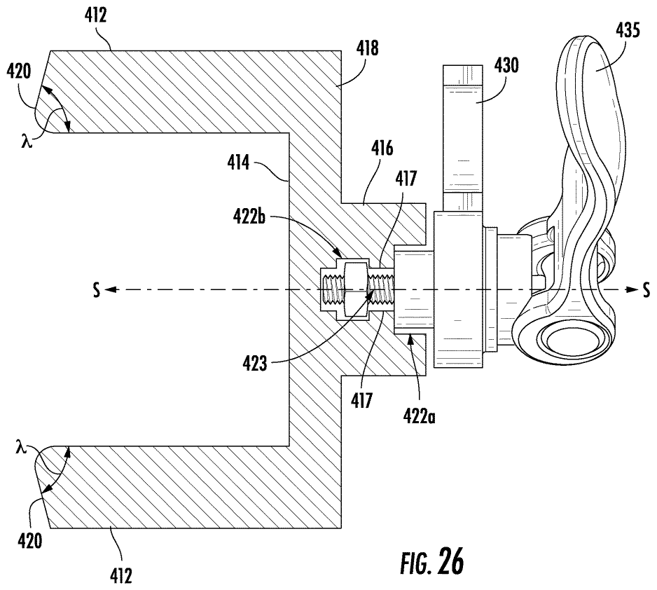

Referring to FIGS. 23-26, another support assembly 400 is shown in accordance with embodiments of the present disclosure. The support assembly 400 includes a bracket 410, a clamp 430, and a probe mount 450. The clamp 430 may be attached to the bracket 410 by a lock 435. The support assembly 400 may be used to fix the probe 66 in small or confined spaces, e.g., where the storage container 100 has a volume in the range of 1 liter to 15 liters. Smaller storage containers 100 may have a frame 110 with side rails 112 that are closer together than a storage container 100 with a larger volume. This may reduce space to access the opening 126 of the bladder 120. The support assembly 400 mounts to the frame 110 of the storage container 100 and secures the probe 66 at a desired position, e.g., the center C, within the bladder 120 of the storage container 100. The support assembly 400 provides at least two degrees of freedom to position the probe 66 within the bladder 120. Specifically, as shown in FIG. 24, the support assembly 400 allows for horizontal, e.g., X-position, and vertical, e.g., Y-position, positioning of the probe 66 within the storage container 100. The length of the probe 66 disposed within the storage container 100, dictates the depth, e.g., Z-position (into the page), the probe 66 penetrates into the bladder 120.

The bracket 410 has a pair of legs 412 extending from a first or backside 414 with a track 416 extending from a second or front side 418. The pair of legs 412 secure the bracket 410 to the frame 110 of the storage container 100. Each leg 412 may extend perpendicularly from the backside 414 of the bracket 410 and terminates in a foot 420. The legs 412 may be spaced apart from each other. In embodiments, the legs 412 may extend from the backside 414 of the bracket 410 parallel to each other. Each foot 420 may be angled a foot angle A relative to the respective leg 412 that the foot 420 terminates. The foot angle 2 may be in a range of 89 degrees to 70 degrees, e.g., 75, 80, or 85 degrees. The bracket 410 may be secured to the storage container 100 by a two-part fastener, e.g., a hook and loop fastener. The first part of the two-part fastener or the second part of the two-part fastener may be adhered to the feet 420 and the other part may be adhered to the frame 110. The engagement between the first part and the second part of the two-part fastener is strong enough to hold the probe 66 at the desired position P, e.g., the center C, during a freezing process or transportation of the storage container 100. For example, the engagement between the first part and the second part of the two-part fastener is such that expansion of the fluid within the bladder 120 does not dislodge the bracket 410 from the frame 110. Additionally or alternatively, the engagement between the first part and the second part of the two-part fastener may resist displacement of the probe 66 when the storage container 100 is moved, e.g., into a freezer before the fluid is frozen. Specifically, the engagement between the first part and the second part of the two-part fastener has a tensile strength in the range of 10 kg/m² to 75 kg/m², e.g., 40 kg/m².

The track 416 may extend perpendicularly from the front side 418 of the bracket 410. The track 416 defines a slot 422 to receive a portion of the clamp 430 and to slidably secure the clamp 430 to the bracket 410. Track 416 and the slot 422 may extend the entire width of the front side 418. Specifically, the track 416 includes eaves 417 extending into the slot 422 to split the slot 422 into an upper slot 422a and a lower slot 422b. The upper slot 422a and the lower slot 422b are connected by a gate 423 defined between the ends of the eaves 417.

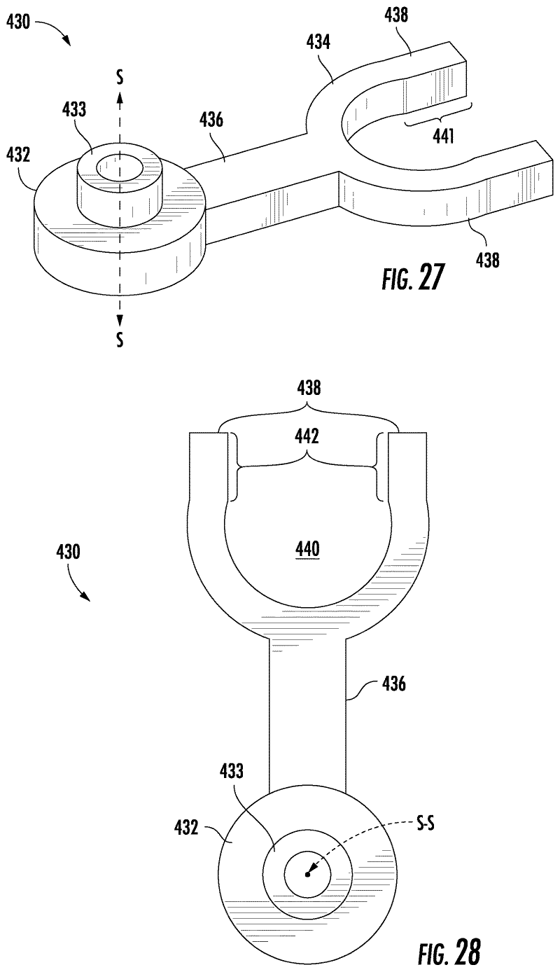

Referring to FIGS. 27 and 28, the clamp 430 includes a connector portion 432, a clamp portion 434, and an arm 436 extending between the connector portion 432 and the clamp portion 434. The connector portion 432 includes a slide guide 433 projecting from the connector portion 432 that defines a pivot axis S-S. The slide guide 433 is received within upper slot 422a and guides the clamp 430 as the clamp 430 translates within the track 416. The pivot axis S-S is defined such that when the slide guide 433 is received within the slot 422 the pivot axis S-S is orthogonal to the front side 418 of the bracket 410. The clamp 430 may pivot about the pivot axis S-S. The clamp 430 may pivot 360 degrees about the pivot axis S-S.

The clamp portion 434 includes a pair of clamp fingers 438. The clamp fingers 438, or more particularly a portion of the clamp fingers 438, define a holder 440 to receive the probe mount 450. Each clamp finger 438 has an end portion 442. The end portions 442 may be spaced apart from each other a distance that is smaller than the distance between the portions of the clamp fingers 438 defining the holder 440. For example, the holder 440 may have a diameter in the range of 10 mm to 40 mm, e.g., 14 mm, and the distance between the end portions 442 may be slightly less than the diameter of the holder 440. Specifically, the distance between the end portions 442 may be 2% to 8% smaller than the diameter of the holder 440. For example, the holder 440 may have a diameter of 14 mm and the end portions 442 may be spaced apart a distance of 13.3 mm (5% smaller than the diameter). The end portions 442 being spaced apart less than the diameter of holder 440 may resist unintended release of the probe mount 450 from the clamp portion 434. The arm 436 extends between the connector portion 432 and the clamp portion 434. The arm 436 may have a length in the range of 5 mm to 50 mm, e.g., 10, 15, 20, or 25 mm.

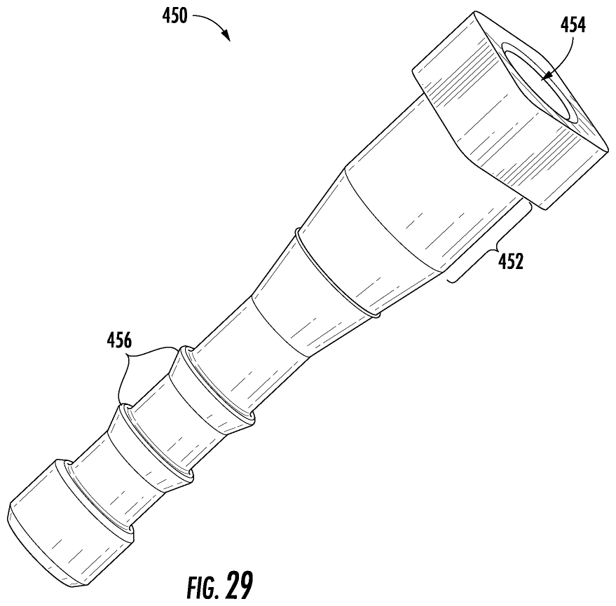

Referring to FIG. 29, the probe mount 450 secures the probe 66 to the support assembly 400. The probe mount 450 is generally tubular and defines a probe port 454 to receive the probe 66. The probe mount 450 receives the probe 66 through the probe port 454 such that the storage container 100 is fluidly sealed through the probe port 454. For example, the probe mount 450 may include gaskets disposed within the probe port 454 to engage the probe 66 to seal the probe port 454. The probe mount 450 may include a clamp segment 452 to be received by the clamp portion 434 of the clamp 430. The clamp segment 452 may have a circular cross-section to be received in the holder 440. The probe mount 450 may have a fitting 456 to fluidly couple the probe mount 450 to the storage container 100. For example, as shown, the fitting 456 may be a barb fitting.

The clamp 430 may be attached to the bracket 410 by the lock 435. The lock 435 extends through the connector portion 432 of the clamp 430 and secures the clamp 430 to the track 416. The lock 435 may be a cam clamp. The cam clamp may have a locked configuration in which the clamp 430 freely slides along the track 416 within the slot 422 and pivots about the pivot axis S-S and a locked configuration in which the clamp 430 is secured at a fixed position.

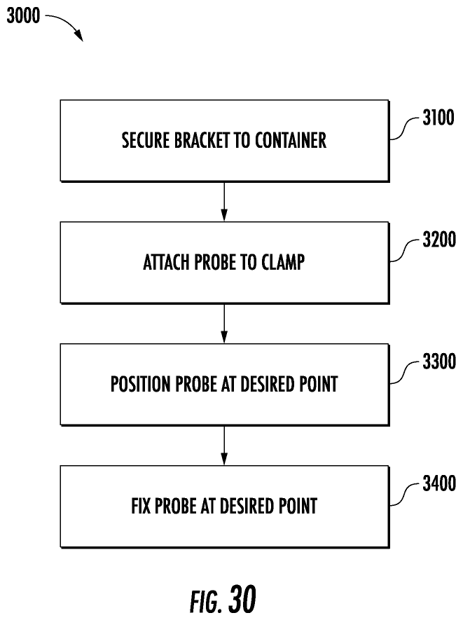

Referring to FIG. 30, a method 3000 of positioning a probe within a container in accordance with embodiments of the present disclosure is described with reference to the storage container 100 of FIGS. 1-3, the positioning system 200 of FIGS. 4-12, and the support assembly 400 of FIGS. 23-29.

The bracket 410 is secured to the frame 110 of the storage container 100 (Step 3100). The feet 420 are engaged with the frame 110 to attach the bracket 410 to a side rail 112. Specifically, the feet 420 may have the first part of a two-part fastener and the side rail 112 may have the second part of the two-part fastener. The two parts of the two-part fasteners may engage to secure the support assembly 400 to the storage container 100. The bracket 410 may be secured to the frame 110 adjacent to the opening 126. When the bracket 410 is secured to the frame 110 the slot 422 of the track 416 may be aligned with the opening 126.

The probe 66 is attached to the clamp 430 (Step 3200). Attaching the probe 66 to the clamp 430 may include inserting the probe 66 into the probe mount 450 through the probe port 454. Attaching the probe 66 to the clamp 430 includes clamping the probe mount 450 to the clamp 430. The probe mount 450 is received between the pair of clamp fingers 438 and into the holder 440. The probe mount 450 may be clamped to the clamp 430 before or after inserting the probe 66 into the probe port 454. The clamp 430 may be attached to the bracket 410 before or after the probe mount 450 is secured to the clamp 430. In embodiments, the clamp 430 may be attached to the bracket 410 before or after the bracket 410 is secured to the frame 110 of the storage container 100.

The probe 66 is positioned at a desired point within the bladder 120 of the storage container 100 (Step 3300). More particularly, the tip portion 67 of the probe 66 is positioned at a desired point P within the bladder 120 to monitor the temperature, or other parameters, of the fluid contained within the bladder 120. The probe 66 is positioned by sliding the clamp 430 with respect to the bracket 410 within the track 416 and pivoting the clamp 430 about the pivot axis S-S. The depth the tip portion 67 extends into the bladder 120 is defined by the length of the probe 66 inserted into the opening 126. The probe 66 may be positioned with the aid of the positioning system 200. As described above, the positioning system 200 may intersect two light beams 223 at the point P, e.g., the desired point for the tip portion 67 of the probe 66, to position the probe 66 within the storage container 100. When the probe 66 obstructs both the light beams 223 the probe 66 is at the desired point. To position the tip portion 67 horizontally within the bladder 120 the clamp 430 may be translated along the track 416 until the tip portion 67 obstructs either one of the light beams 223a, 223b. Once the horizontal position for the tip portion 67 is found, the tip portion 67 may be position vertically within the bladder 120. To position the tip portion 67 vertically the clamp 430 translates within the track 416 and pivots about the pivot axis S-S. The combined translation and pivoting may allow for vertical placement of the tip portion 67 while the horizontal position is maintained. The direction the tip portion 67 needs to move to be positioned at the desired point P may be indicated by which of the light beams 223a, 223b the tip portion 67 obstructs during horizontal positioning. For example, with brief reference back to FIG. 9, if the tip portion 67 is only obstructing the light beam 223b, then moving the tip portion 67 downward will move the tip portion 67 towards the desired point P. If the tip portion 67 is only obstructing the light beam 223a, then moving the tip portion 67 upward will move the tip portion 67 towards the desired point P. In embodiments, the probe 66 may be positioned before or after the bladder 120 is filled with a fluid.

The probe 66 is fixed at the desired point (Step 3400). Specifically, the clamp 430 is fixed with respect to the bracket 410 and the storage container 100. The clamp 430 is fixed by moving the lock 435 to the locked configuration. Fixing the clamp 430 resists displacement of the tip portion 67 from the desired point P during subsequent processes, e.g., freezing processes.

Although the method steps are described in a specific order, it should be understood that other steps may be performed in between described steps, described steps may be adjusted so that they occur at slightly different times, or the described steps may occur in any order unless otherwise specified.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

1. A positioning system comprising:
a base having a first side and a second side opposite the first side;
a first holder secured to the base, the first holder defining a first receptacle and a first holder axis that extends through the first receptacle orthogonal to the first side of the base, the first holder configured to receive a first beam generator that emits a first light beam through the base coaxial with the first holder axis; and
a second holder secured to the base, the second holder defining a second receptacle and a second holder axis that extends through the second receptacle askew to the first holder axis such that the first holder axis and the second holder axis intersect at a predetermined distance from the second side of the base, the second holder configured to receive a second beam generator that emits a second light beam through the base coaxial with the second holder axis, the second holder axis spaced apart from the first holder axis at the first side of the base.

2. The positioning system according to claim 1, wherein the second holder is configured to slide in a first direction to increase the predetermined distance from the second side of the base that the first holder axis and the second holder axis intersect and slide in a second direction to decrease the predetermined distance from the second side of the base that the first holder axis and the second holder axis intersect.

3. The positioning system according to claim 1, wherein the first holder includes a first projection extending into the first receptacle, the first projection configured to selectively switch the first beam generator between an on-state in which the first beam generator produces the first light beam and an off-state when the first beam generator is received in the first receptacle.

4. The positioning system according to claim 1, wherein the second holder axis is angled with respect to the first holder axis in a range of 20 degrees to 80 degrees.

5. The positioning system according to claim 1, wherein the first holder axis and the second holder axis are spaced apart a distance in a range of 5 mm to 55 mm at the first side of the base.

6. An apparatus comprising:
a storage container having a first side and a second side opposite the first side, the storage container defining an interior of the storage container between the first side and the second side;
a first beam generator having an on-state in which a first light beam is emitted;
a second beam generator having an on-state in which a second light beam is emitted; and
a positioning system according to claim 1 mounted to the first side of the storage container, the first beam generator disposed within the first holder of the positioning system and the second beam generator disposed within the second holder of the positioning system, the first light beam and the second light beam intersecting at a desired point within the interior of the storage container.

7. The apparatus according to claim 6, further comprising a probe disposed within the interior of the storage container with a tip portion of the probe at the desired point.

8. The apparatus according to claim 7, further comprising a support assembly secured to the storage container, the support assembly comprising:
a bracket configured to secure to the storage container;
a boom slidably coupled to the bracket, the boom slidable relative to the bracket in two degrees of freedom; and
a probe mount securing the probe to the boom such that sliding the boom with respect to the bracket positions the tip portion of the probe within the storage container at the desired point.

9. The apparatus according to claim 7, further comprising a support assembly secured to the storage container, the support assembly comprising:
a bracket configured to secure to the storage container;
a clamp slidably attached to the bracket, the clamp slidable relative to the bracket in one degree of freedom, the clamp pivotable about a clamp axis thereof, and
a probe mount received by the clamp, the probe mount securing the probe to the clamp such that sliding or pivoting the clamp positions the tip portion of the probe within the storage container at the desired point.

10. An apparatus comprising:
a storage container having a first side and a second side opposite the first side;
a positioning system mounted to the first side of the storage container, the positioning system comprising:
a base;
a first holder secured to the base;
a first beam generator disposed within the first holder, the first beam generator configured to emit a first light beam that extends orthogonal to the base and that passes through the storage container;
a second holder secured to the base; and
a second beam generator disposed within the second holder, the second beam generator configured to emit a second light beam that extends askew to the first light beam and that passes through the storage container, the first light beam and the second light beam intersecting at a desired point within the storage container; and
a probe disposed within the storage container with a tip portion of the probe at the desired point.

11. The apparatus according to claim 10, further comprising a first sensor configured to detect the first light beam and a second sensor configured to detect the second light beam.

12. The apparatus according to claim 11, wherein the first sensor and the second sensor are photoresistors.

13. The apparatus according to claim 11, wherein the first sensor and the second sensor are positioned adjacent to and spaced apart from the second side of the storage container.

14. The apparatus according to claim 10, wherein the storage container includes a bladder, the bladder allowing transmission of light therethrough and having a volume in a range of 5 liters to 100 liters, the positioning system mounted to the storage container.

15. The apparatus according to claim 10, further comprising a support secured to the storage container, the support comprising:
a bracket including a header, a pair of arms extending from the header, a first leg extending from the header, and a second leg extending from the header, the pair of arms securing the bracket to the storage container, the first leg and the second leg spaced apart to define a window therebetween;
a boom, the boom slidably coupled to the first leg and the second leg such that the boom spans the window; and
a probe mount securing the probe to the boom such that sliding the boom with respect to the bracket positions the probe within the window, the probe mount and the boom securing the tip portion of the probe within the storage container at the desired point.

16. The apparatus according to claim 15, wherein the first leg defines a first slot and the second leg defines a second slot; and
wherein the boom defines a third slot and a fourth slot, the boom slidable toward or away from the header along the first slot and the second slot, the boom slidable transverse to the first leg and the second leg along the third slot and the fourth slot.

17. The apparatus according to claim 15, wherein the storage container further comprises a frame, the pair of arms securing the bracket to the frame such that an opening of the storage container is located between the first leg and the second leg, the probe disposed with the storage container through the opening.

18. The apparatus according to claim 10, further comprising a support assembly secured to the storage container, the support assembly comprising:
a bracket having a first side and a second side opposite the first side, the bracket including a pair of legs extending from the first side and a track extending from the second side, the pair of legs securing the bracket to the storage container, the track defining a slot extending therethrough;
a clamp slidably attached to the track and slidable along the slot, the clamp pivotable about a clamp axis thereof; and
a probe mount received by the clamp, the probe mount securing the probe to the clamp such that sliding or pivoting the clamp positions the tip portion of the probe within the storage container at the desired point.

19. The apparatus according to claim 18, further comprising a two-part fastener including a first part and a second part, the first part of the two-part fastener adhered to each foot of the bracket and the second part of the two-part fastener adhered to the storage container, engagement of the first part and the second part of the two-part fastener securing the bracket to the storage container.

20. A method of positioning a probe within a storage container, the method comprising:
mounting a positioning system on a first side of the storage container, the positioning system including a first beam generator configured to emit a first light beam that passes through the storage container and a second beam generator configured to emit a second light beam that passes through the storage container and intersects the first light beam at a desired point within the storage container; and
positioning the probe within the storage container at the desired point.

21-80. (canceled)
